(19) United States
(12) Patent Application Publication
(10) Pub. No.: US 2025/0118162 A1
(43) Pub. Date: Apr. 10, 2025

(54) GAMING SYSTEMS AND METHODS WITH PERSISTENT MULTI-STATE GAME FEATURES

(71) Applicant: LNW Gaming, Inc., Las Vegas, NV (US)

(72) Inventors: Michael W. TUCKER, Chicago, IL (US); Brett GRIMES, Chicago, IL (US)

(21) Appl. No.: 18/891,053

(22) Filed: Sep. 20, 2024

Related U.S. Application Data
(60) Provisional application No. 63/588,369, filed on Oct. 6, 2023.

(51) Int. Cl. G07F 17/32

(52) U.S. Cl. CPC G07F 17/3267; G07F 17/3262

(57) ABSTRACT

There is provided a gaming system that utilizes game-logic circuitry and a presentation assembly for presenting a multi-state bonus game. The bonus game is conducted with a first bonus game feature for a first duration by the presentation assembly presenting a bonus game interface including one or more modifiable game elements associated with the first bonus game feature, presenting first bonus game outcomes, and, in response to detecting a modifier event, updating at least one of the modifiable game elements based on the modifier event. In response to the first duration concluding, the bonus game is conducted with a second bonus game feature for a second duration, wherein the updated modifiable game elements persist between the bonus game features. The bonus game within the second duration includes the presentation assembly presenting second bonus game outcomes based on the second bonus game feature and the updated modifiable game elements.

### CROSS-REFERENCE TO RELATED APPLICATIONS

This application claims the benefit of priority to U.S. Provisional Application No. 63/588,369, filed Oct. 6, 2023, the contents of which are hereby incorporated by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### FIELD OF THE INVENTION

The present invention relates to a technological improvement to gaming systems, gaming machines, and methods and, more particularly, to technological improvements in connection with multi-state persistent games.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple game features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to embodiments of the present invention, there are provided a gaming machine and method that utilize game-logic circuitry and a presentation assembly configured to present a gaming session comprising a base game and a multi-state bonus game including a first bonus game feature and a second bonus game feature. The game-logic circuitry conducts conduct the base game by causing the presentation assembly to present a base game interface including a plurality of symbol-bearing base reels, a base array, and a plurality of persistent elements including a first persistent element associated with the first bonus game feature and a second persistent element associated with the second bonus game feature, where the base reels are spun and stopped to land symbols form the base reels in the base array. In response to the landed symbols including a feature-triggering symbol associated with the first persistent element and a feature-triggering symbol associated with the second persistent element, the presentation assembly animates an addition of the feature-triggering symbol to the associated persistent element, and the game-logic circuitry randomly determines whether or not to trigger the first bonus game feature and the second bonus game feature. In response to triggering the first bonus game feature and the second bonus game feature, the game-logic circuitry conducts the bonus game with the first bonus game feature for a first duration while the second bonus game feature is inactive. The first bonus state includes the presentation assembly presenting a bonus game interface including a plurality of symbol-bearing bonus reels a bonus array and one or more modifiable game elements associated with the first bonus game feature, presenting one or more first bonus game outcomes by spinning and stopping the plurality of bonus reels to land symbols from the bonus reels in the bonus array, and, in response to detecting the first bonus game outcomes including a modifier event of the first bonus game feature, updating at least one of the modifiable game elements based on the modifier event, wherein the modifier event is inactive within the base game. In response to the first duration concluding, the game-logic circuitry conducts the bonus game with the second bonus game feature for a second duration with the bonus game interface of the presentation assembly, wherein the updated modifiable game elements persist between the first bonus game feature and the second bonus game feature. The bonus game within the second duration includes causing the presentation assembly to present one or more second bonus game outcomes based on the second bonus game feature and the at least one updated modifiable game elements.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIGS. 3A and 3B are a flow diagram for a data processing method that corresponds to instructions executed by a controller, according to an embodiment of the present invention. FIG. 3A relates to a base-game portion of a wagering game; FIG. 3B relates to a game feature that may be triggered during play of the base game.

FIG. 4 is an exemplary presentation of a base-game spin outcome resulting from the flow diagram in FIG. 3A.

FIG. 5 is a flow diagram of an example method for conducting and presenting a multi-state bonus game, according to an embodiment of the present invention.

FIG. 6 is an example game interface for a base game, according to an embodiment of the present invention.

FIG. 7A is the game interface shown in FIG. 6 for a bonus game with a hold and respin game feature, according to an embodiment of the present invention.

FIG. 7B is the game interface shown in FIG. 7A with a plurality of selectable awards, according to an embodiment of the present invention.

FIG. 7C is the game interface shown in FIG. 7A following an award selection sequence, according to an embodiment of the present invention.

FIG. 8A is the game interface shown in FIG. 6 for a bonus game with an array expansion game feature, according to an embodiment of the present invention.

FIG. 8B is the game interface shown in FIG. 8A following an array expansion sequence, according to an embodiment of the present invention.

FIG. 9A is the game interface shown in FIG. 6 for a bonus game with a persistent award game feature, according to an embodiment of the present invention.

FIG. 9B is the game interface shown in FIG. 9A with a plurality of award symbols, according to an embodiment of the present invention.

FIG. 9C is the game interface shown in FIG. 9A following a persistent award sequence, according to an embodiment of the present invention.

FIG. 10A is the game interface shown in FIG. 6 for a multi-state bonus game in a first bonus game state, according to an embodiment of the present invention.

FIG. 10B is the game interface shown in FIG. 10A at the initiation of a second bonus game state, according to an embodiment of the present invention.

FIG. 10C is the game interface shown in FIG. 10A during a bonus game outcome of the second bonus game state, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

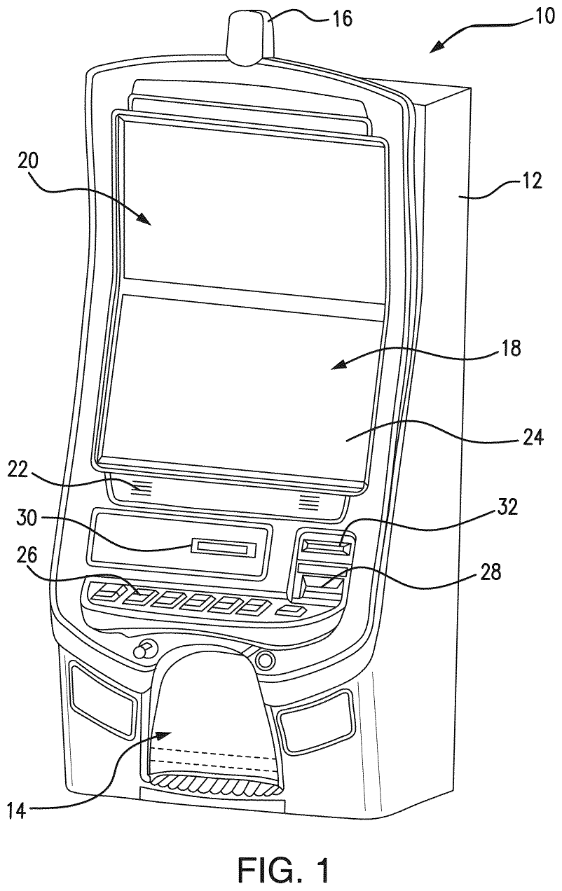

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

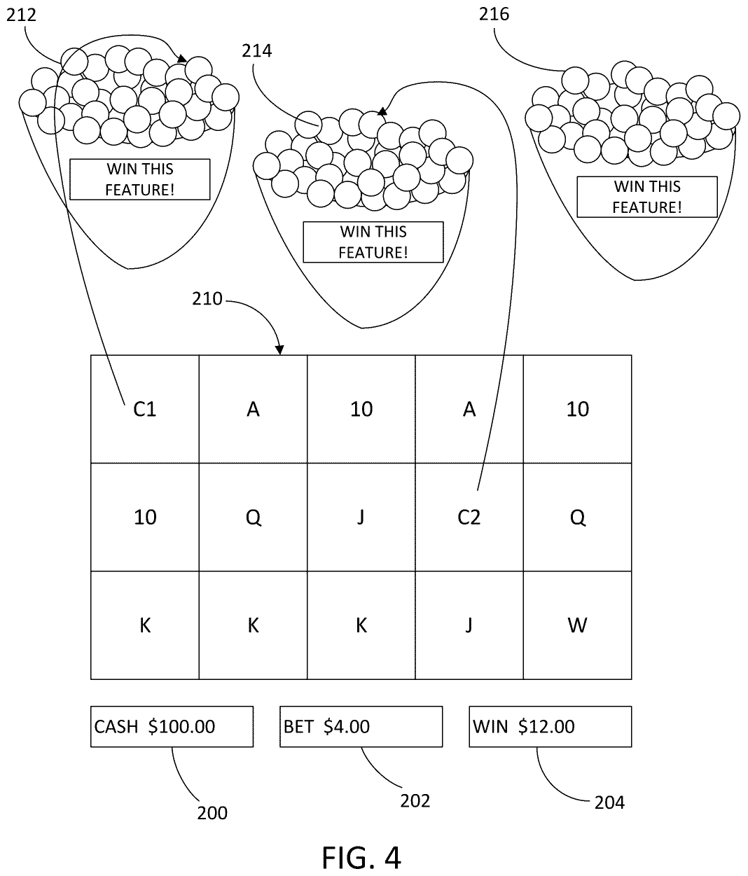

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

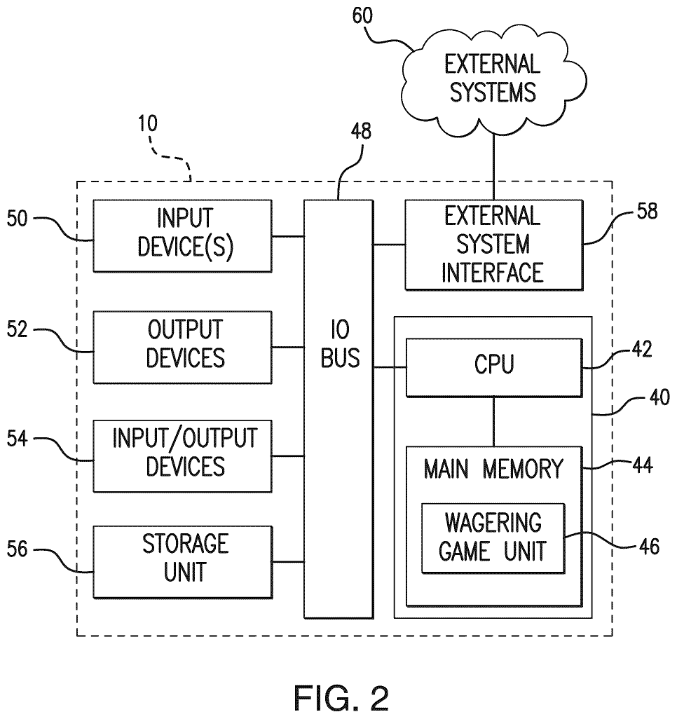

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

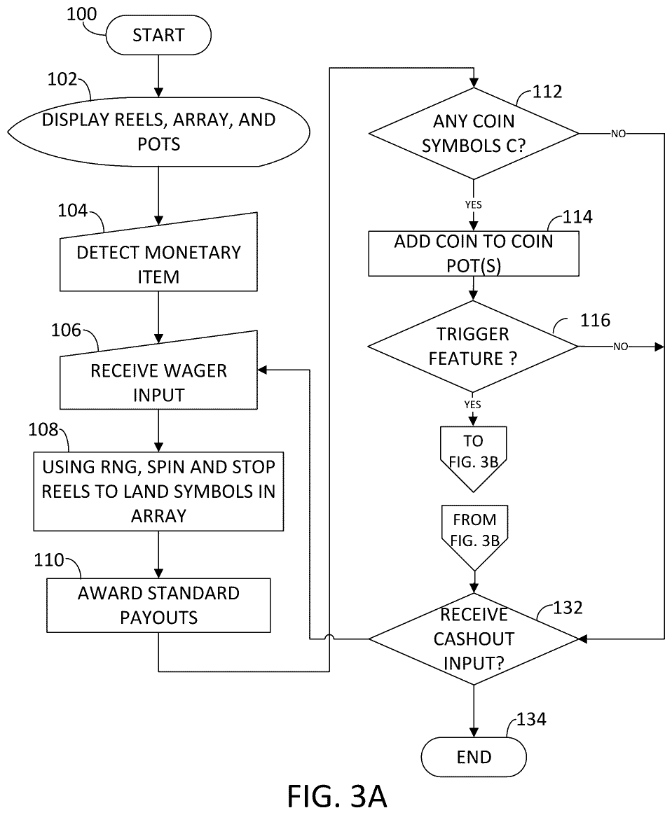

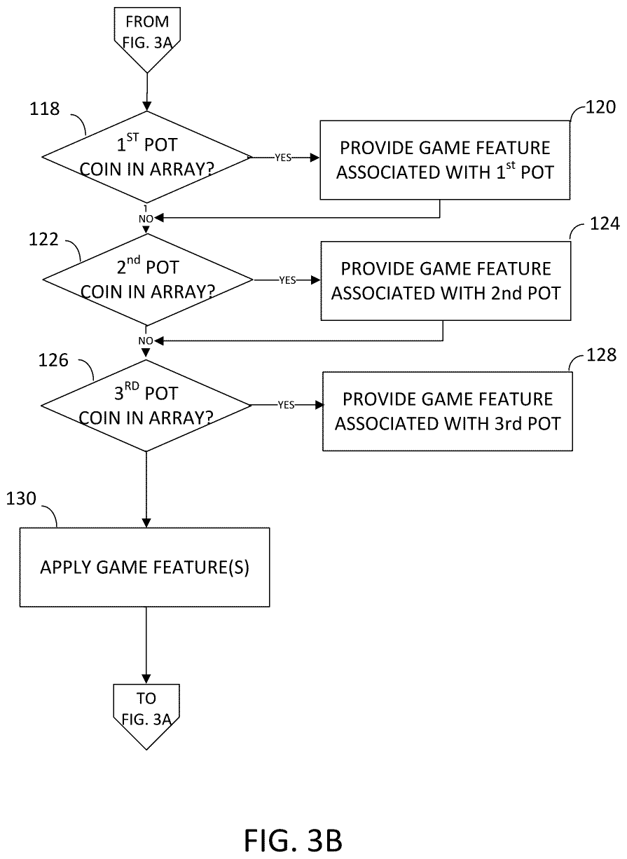

Referring now to FIGS. 3A-3B, there is shown a flow diagram representing one data processing method corresponding to at least some instructions stored and executed by the game-logic circuitry 40 in FIG. 2 to perform operations according to an embodiment of the present invention. The data processing method is described below in connection with the exemplary presentation of a spin outcome in FIG. 4.

Referring to FIG. 3A, the data processing method commences at step 100. At step 102, the game-logic circuitry controls one or more presentation devices (e.g., mechanical-reel display device, video display device, or a combination thereof) to present a plurality of symbol-bearing reels, an array of symbol positions, and a feature-triggering perceived persistent element (e.g., one or more coin pots). Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. Alternatively, the symbol positions may be arranged in a honeycomb configuration with adjacent columns vertically offset from each other by one-half symbol position or adjacent rows horizontally offset from each other by one-half symbol position. The number of symbol positions in different rows and/or different columns may vary from each other. The reels may be associated with the respective columns of the array such that the reels spin vertically and each reel populates a respective column. In another embodiment, the reels may be associated with the respective rows of the array such that the reels spin horizontally and each reel populates a respective row. In some embodiments, the reels are associated with respective individual symbol positions of the array such that each reel animates in place and populates only its respective symbol position. The symbol array configuration may vary between the base game and any bonus games and/or other game features utilizing the array.

In FIG. 4, the symbol array 210 in the base game has a three-by-five rectangular configuration, and each symbol position is associated with a respective independent reel. The reels bear a plurality of symbols that may, for example, include royal symbols 10, J, Q, K, and A; a wild symbol W that can substitute for any of the royal symbols; and generic coin symbols C1, C2, C3.

In one or more embodiments, the plurality of symbols also includes value-bearing symbols, otherwise known as WYSIWYG (“What You See is What You Get”) or “cash on reels” symbols. In certain embodiments, the coin symbols C1, C2, C3 may be value-bearing symbols. Each value-bearing symbol is associated with a credit or currency value indicated on the symbol itself. The value on a particular credit-bearing symbol may be fixed or variable (e.g., random) from one game cycle to the next. Different value-bearing symbols on the reels may have different values. In one or more embodiments, a value-bearing symbol may be associated with a value determined or displayed separately. For example, rather than a specific amount, a GRAND, MAJOR, MINOR, or MINI award label may be indicated on a value-bearing symbol. Each reel may contain one or more stacks (i.e., clumps) of value-bearing symbols that appear adjacent to each other along the reel. The values of the value-bearing symbols in any given stack may be the same or different. A stack of value-bearing symbols may consist of two, three, four, or more adjacent symbols. Further, adjacent reels may contain one or more “mega” value-bearing symbols that move as one block as the reels spin. When the spin is complete, each individual row and column of the array underlying any visible portion of the “mega” symbol is assigned the value associated with the “mega” value-bearing symbol. For example, a “mega” value-bearing symbol may comprise two-row high square spanning the first two columns of the array 210. If this symbol stops aligned with the top two rows of the array 210, the symbols in the first two rows and first two columns would all be treated as though individual value-bearing symbols having the value of the “mega” symbol had landed in those locations.

At step 104, the game-logic circuitry detects, via a value input device, a physical item associated with a monetary value that establishes a monetary balance in the form of cash or credits. In FIG. 4, the monetary balance may be shown on a credit meter 200.

At step 106, the game-logic circuitry initiates a base game of a wagering game cycle (i.e., spin cycle) in response to an input indicative of a wager covered by the monetary balance. To initiate a spin of the reels, the player may press a “Spin” or “Max Bet” key on a button panel or touch screen. In FIG. 4 the wager may be shown on a bet meter 202.

At step 108, using an RNG, the game-logic circuitry spins and stops the reels to randomly land symbols from the reels in the array in visual association with one or more paylines (also known as lines, ways, patterns, or arrangements). The reel spin may be animated on a video display by depicting symbol-bearing strips moving vertically across the display and synchronously updating the symbols visible on each strip as the strip moves across the display. Alternatively, the reels may be physical/electromechanical reels. FIG. 4 depicts a base-game spin outcome.

At step 110, the game-logic circuitry awards standard payouts in accordance with a pay table. The pay table may, for example, include “line pays,” “ways pays” and “scatter pays.” Line pays occur when a predetermined type and number of symbols appear along an activated payline, typically in a particular order such as left to right, right to left, top to bottom, bottom to top, etc. Ways pays appear on adjacent reels without the requirement to be on a specified pay line or directly adjacent to one another. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. To animate a standard pay, the display may apply a border, pattern, color change, background change, watermark, or other distinguishing characteristic to the winning payline and/or winning symbols that contributed to the pay. FIG. 4, for example, depicts a line pay of three K symbols in the bottom row of the array 210. The awarded pay is added to a win meter 204.

At step 112, the game-logic circuitry determines whether or not any coin symbols C1, C2 or C3 landed in the array. If a coin symbol C1, C2 or C3 did not land in the array, the game-logic circuitry immediately proceeds to step 132. If, however, one or more coin symbols C1, C2 or C3 landed in the array as shown in FIG. 4, the game-logic circuitry proceeds to step 114. At step 114, the game-logic circuitry animates the addition of each coin symbol C1, C2 or C3 to a persistent element such as a coin pot (FIG. 4; 212, 214, 216) associated with the respective coin symbol C1, C2 or C3. For example, the coin symbol C2 in the center column of FIG. 4 may be animated to “fly” off the array and land in the middle of its associated coin pot 212. To represent the addition of the coin symbol to the coin pot, the pot and/or the volume of coins therein may appear to grow in size. In FIG. 4, the transfer of the coin symbol C2 to the middle coin pot 214 is represented by an arrow. The persistent elements may take forms other than the coin pots 212, 214, 216, including for example urns, vases, jars, jugs, cans, bowls, piggy banks, beehives, inflating balloons, ladders, dials, meters, etc. In accordance with some embodiments, the persistent element may be an object of fixed size accompanied by some other indication of accumulating value, for example, by a gradual change in color. In other embodiments, the persistent element may change size and also show some other indication of increasing value, for example, the color of the display in the immediate area of the persistent element may gradually change as its value increases.

During a player's gaming session, the growth in size of the coin pots 212, 214 216 in FIG. 4 may persist from one wagering game cycle to the next such that the player perceives that the corresponding game feature may be getting closer to being triggered. This kind of game is known as a “perceived persistence” game. Unlike a true “persistence game,” wherein the size of each coin pot or the observable quantity of its contents serves as an indication of the probability that its associated bonus or game feature will be triggered. In both cases, when the bonus or game feature associated with a pot is triggered, at least some of the contents of the pot are visually removed and the accumulation of coins in that pot during subsequent game spin cycles resumes from that point.

In the perceived persistence embodiments described herein, at step 116, if at least one coin symbol C1, C2, or C3 appears in the array, the game-logic circuitry randomly determines, via the RNG, whether or not to trigger one or more game features of varying types, described below. This random determination is independent of any prior wagering game cycles. In at least some embodiments, the game-logic circuitry is configured to determine whether or not to trigger a game feature independently for each coin symbol in the array. In other embodiments, the game-logic circuitry performs one determination for all coins present within the array or a subset of the coins. For example, for each type of coin present in the array, one determination may be executed by the game-logic circuitry such that up to three determinations are performed for a given game outcome including coin symbols.

In some embodiments, a game feature simply awards a prize, for example a fixed or progressive jackpot amount. In certain embodiments, the prize or award is awarded in response to a game feature not being triggered or is awarded irrespective of the game feature triggering or not. In such embodiments, the value of award may be randomly determined, predetermined (e.g., selected from a predefined set of awards), or based on the state of the persistent element, where the persistent element has a plurality of perceived states, each perceived state associated with one or more available award values.

In some embodiments, a game feature may comprise any type of bonus game. The term “bonus game” as used herein refers to a game feature that functions through additional, fewer, or alternative game logic and/or game elements relative to the base game feature. Non-limiting examples of bonus games include a certain number of free games (i.e., spins of the reels), a “pick′ em” bonus game, a wheel-spinning game, etc. In embodiments offering a free spin bonus game, the free spins may be played as a “hold and spin” game in which certain types of symbols, once landed in the array, are held in place and persist in the array for at least one additional free spin cycle. These persistent symbols may include value-bearing (“WYSIWYG”) symbols, wild symbols or other symbols that may improve the chances of winning or provide higher pays. In still other embodiments, a bonus game may be played to determine a game enhancement (described further below) or payment of prize, for example, a fixed or progressive jackpot (described above). The game enhancement may be applied to an outcome of the bonus game, the current base game or one or more future play cycles of the same bonus game, a different bonus game or the base game.

In the example embodiment, as described in detail further herein, the gaming system includes a multi-state bonus game. The bonus game selectively includes modular game features based on the trigger events associated with the coin symbols. The bonus game includes one or more common or shared bonus game elements (e.g., symbol array, sets of available symbols, jackpot awards, etc.) for use between all or a portion of the modular game features. Each modular game feature is configured to include one or more unique game elements (which may include different weight parameters of symbols for random selection, enhanced awards tables, etc.) and/or game events to distinguish between bonus game features. These bonus game features are “modular” in the sense that a bonus game instance can be initiated with one or more concurrent bonus game features. In some embodiments, all combinations of the available bonus game features are available. In other embodiments, some bonus game features may be modular, while other bonus game features are configured to be conducted within an independent bonus game instance. For example, two bonus game features may be modular features of a symbol array-based bonus game, while a third bonus game feature may be associated with an independent award wheel bonus game.

In the embodiments described herein, in addition to the modular bonus game features, the bonus game is configured to be performed within a plurality of bonus game states for bonus game instances with a plurality of active bonus game features. For example, for a bonus game instance being triggered for two bonus game features, a first state of the bonus game is configured to include a first bonus game feature, and a second, subsequent state of the bonus game is configured to include a second bonus game feature. At least one game element persists between the two states such that game changes occurring in the first state affect the second state via the persistent game elements. For example, the symbol array may be configured to expand or otherwise change in the first state, and the modified symbol array persists to the second state. In another example, a persistent award is established and increased in response to value collection events occurring within the first state, where the persistent award is available for collection within the second state. In some embodiments, the bonus game within the second state includes both the first bonus game feature and the second bonus game feature such that the game changes may occur throughout both the first and second states, and the second state provides enhanced or active game aspects (e.g., award events) unavailable within the first state.

In some embodiments, a game feature may comprise an enhancement to the game. An enhancement may include, without limitation, pay table modifiers such as multipliers, increased values on value-bearing symbols, modification to the reels to include improved symbols, such as wild symbols or symbol weights or the removal of certain “blocking symbols”, additional rows or columns added to the array, additional free spins, replacement symbols for symbols already present in the array, etc. The enhancement may be applied to the current base game outcome or may be applied to one or more subsequent game features or wagered base game plays.

If a game feature is not triggered at step 116, the spin cycle is complete, and the game-logic circuitry proceeds to step 132. If, however, a game feature was triggered at step 116, the game-logic circuitry instead proceeds to the flow in FIG. 3B to determine which of one or more game features have been triggered according to the specific coin C1, C2 and C3 present in the array. More specifically, in the example embodiment and in response to triggering one or more game features, a bonus game instance is initiated as described herein.

At step 118 in FIG. 3B, the game logic circuitry determines if a coin C1 associated with the left pot 212 is present in the array. If not, the method proceeds to step 122, otherwise, a game feature associated with the left pot 212 is enabled at step 120.

At step 122, the game logic circuitry determines if a coin C2 associated with the middle pot 214 is present in the array. If not, the method proceeds to step 126, otherwise, a game feature associated with the middle pot 214 is enabled at step 124.

At step 126, the game logic circuitry determines if a coin C3 associated with the right pot 216 is present in the array. If not, the method proceeds to step 130, otherwise, a game feature associated with the middle pot 214 is enabled at step 128.

In other embodiments, rather than a single trigger determination at step 116, the step 116 is incorporated into the steps 118-128. More specifically, the steps 118, 122, and 126, in addition to detecting the presence or absence of coins within the array, include independent determinations of whether or not to trigger a corresponding game feature.

Depending on which coins C1, C2 and C3 are present in the array, it is possible for more than one of the above-described game features to be applied to the bonus game. In at least some embodiments, the game features are modular aspects of the bonus game such that triggering multiple game features results in a bonus game instance incorporating all of the triggered bonus game features concurrently. The bonus game may be a multi-state bonus game, where triggering a plurality of bonus game features causes the bonus game to initiate a plurality of states with a different (or different combinations of) bonus game features being activate, thereby resulting in different game events and/or game changes occurring within each bonus game state.

Each game feature has a different impact on the expected value (EV) of the game. The relative frequency of the game features may be controlled by adjusting how frequently the associated coins C1, C2 and C3 appear in the array, for example, by their relative weighted appearances on the reels. Thus, a less lucrative game feature may be won more frequently, for example, approximately once in every ten game spin cycles, while a higher paying game feature may only occur approximately once in every one hundred game spin cycles. This allows game features to be triggered more often, for player enjoyment, while maintaining the overall expected EV of the wagering game.

At step 130, the game-logic circuitry applies any of the triggered game features to the gaming session. The presentation assembly is configured to present the application of the game features through one or more suitable animations and/or game interface transitions (e.g., changes to the game and/or presentation elements within the interface). For at least some game features, the game-logic circuitry initiates a corresponding bonus game and applies the game features to the bonus game. Example embodiments of modular, multi-state bonus games that may be used with the method shown in FIGS. 3A and 3B are described herein. The presentation assembly is configured to present a transition sequence from the base game to the bonus game through one or more animations to visibly convey the transition between games.

The following step 130, the gaming session continues until a cashout input is detected at step 132. The gaming session may include subsequent game outcomes of the base game (i.e., the steps of the method shown in FIGS. 3A and 3B) and/or a bonus game instance, where the bonus game is configured to continue for a limited duration before returning to the base game. The duration may be defined by a number of bonus game outcomes, a period of time, a number of particular game events (e.g., the presence or absence of a certain symbol within the bonus game outcomes), and/or the like. The duration may be predefined or dynamic, where a dynamic duration is defined, extended, reduced, or otherwise adjusted through play of the bonus game.

To present the bonus game and any bonus game features enabled in steps 118-128, at step 130 the game-logic circuitry may control one or more presentation devices (e.g., mechanical-reel display device, video display device, or a combination thereof) to present a bonus game array. The bonus game array may have the same configuration as the base game array or may have a different configuration than the base game array. In some embodiments, the bonus game includes additional or alternative game elements for presenting bonus game outcomes via the presentation assembly. For example, in place of a symbol array, the bonus game may use one or more segmented symbol wheels for selecting symbols defining a bonus game outcome.

Example bonus games are described in detail further herein. In response to determining the bonus game has concluded, the presentation assembly is configured to present a transition sequence to transition the game interface from a bonus game interface to a base game interface, which may include additional, fewer, or alternative game and/or presentation elements relative to each other. In returning to the base game, the method continues at step 132.

At step 132, the game-logic circuitry determines whether or not it has received a cashout input via at least one of the one or more player input devices of the gaming machine. If it has not received a cashout input, the game-logic circuitry waits for the next wager input at step 106. If it has received a cashout input, the game-logic circuitry initiates a payout from the monetary balance on the meter 200 in FIG. 4. The data processing method then ends at step 134.

The recitations of a value input device for establishing a credit balance, an input device for accepting a wager input that initiates a spin, and a value output device for paying out the credit balance are integrally incorporated within the steps of the data processing method. For example, the presentation of game outcomes through the spinning and stopping of the reels is essential to the game outcome determinations, which may only be initiated by the accepted wager input. Furthermore, a value input device for establishing a credit balance, an input device for accepting a wager that initiates a spin, and a value output device for paying out the credit balance are physical, structural elements that are not shared by generic or well-known computing devices but, rather, are particular to gaming machines.

Embodiments of the present invention realize benefits in increased computer processing efficiency with minimized processing overhead, fewer rules to be evaluated, fewer player inputs to be monitored, and simpler graphical representations. With respect to the game feature triggering process, if no coin symbol C1, C2 or C3 appears in the array at step 112, the game-logic circuitry foregoes any random determination of whether a game feature will be awarded. Furthermore, if any coin symbols do appear in the array, regardless of the number of pots and associated game features that may be won in parallel, only a single invocation of the RNG at step 116 is required in at least some embodiments to determine whether any game feature will actually be triggered. In contrast, in typical prior art systems with mystery bonus triggers, the game-logic circuitry makes a random determination in each and every wagering game cycle and for each and every game feature that may be won, thereby reducing processing efficiency compared to the method presented herein.

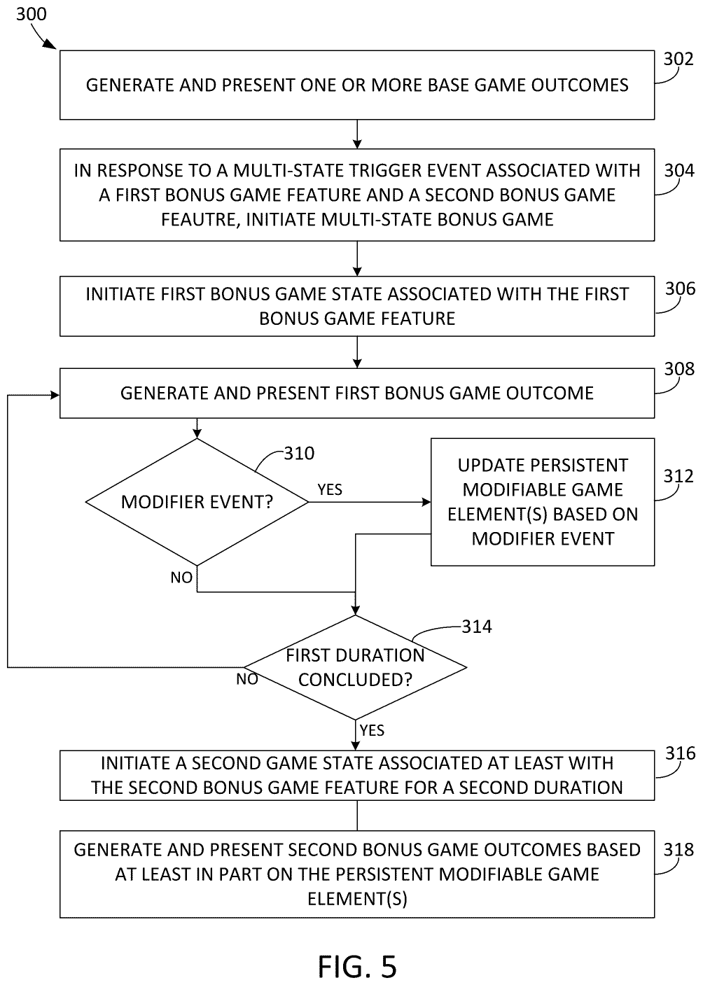

FIG. 5 depicts a flow diagram of an example method 300 for conducting a multi-state bonus game using a gaming system (e.g., the system shown in FIGS. 1 and 2). The method 300 is performed using game-logic circuitry of the gaming system and a presentation assembly of a gaming machine within the gaming system. The game-logic circuitry may be separate from, partially integrated with, or wholly integrated within the gaming machine. The game-logic circuitry is in communication (directly or indirectly) with the presentation assembly to facilitate the functionality described herein. In other embodiments, the method 300 includes additional, fewer, or alternative steps and/or is performed by another suitable configuration of devices within the gaming system. For example, steps from the method shown in FIGS. 3A and 3B may be integrated with the steps of the method 300.

The method 300 begins within a base game of a gaming session. In the example embodiment, the base game is presented via a base game interface presented by the presentation assembly. The base game interface includes a base symbol array associated with a plurality of base symbol-bearing reels and a plurality of persistent elements configured for presenting base game outcomes generated by the game-logic circuitry. In other embodiments, the base game interface includes additional and/or alternative game elements for play of the base game.

At step 302, the game-logic circuitry generates one or more base game outcomes, and the presentation assembly is configured to present game outcome sequences (e.g., animations and/or other presentation changes to the base game interface to visibly convey the outcomes) for the base game outcomes. In response to each base game outcome, the game-logic circuitry is configured to perform one or more outcome determinations to detect any game events and/or conditions resulting from the base game outcome. For example, winning symbol combinations are detected, and an award sequence associated with the winning symbol combinations are presented. Other suitable steps associated with the base game and the base game outcomes may be found, for example, in FIGS. 3A and 3B.

In the example embodiment, the game-logic circuitry is configured to detect any trigger events within each base game outcome. A plurality of trigger event types is available within the base game, where each type of trigger event may be associated with a persistent game element within the base game interface. The relation between a trigger event type and a persistent element may be visually conveyed by the presentation assembly through shared and/or supplemental visual characteristics and/or indicia between the trigger event type and persistent element. In at least some embodiments, each trigger event type is associated with a different trigger symbol available within the base game. In other embodiments, the trigger events are not associated with persistent elements and/or any trigger symbols but are visually and functionally distinct from other trigger events through other suitable presentations.

Similar to the method of FIGS. 3A and 3B, the game-logic circuitry is configured to detect any trigger symbols within from the symbols forming a base game outcome. In some embodiments, the trigger event is automatically active in response to the presence of the trigger symbol. In other embodiments, including the example embodiment, the game-logic circuitry performs one or more random determinations to determine whether or not a trigger event is active in response to detecting at least one trigger symbol.

At least some of the trigger events are associated with a bonus game and different bonus game features. That is, different bonus game features are associated with one or more respective trigger event types. If the trigger event is activated or detected, the game-logic circuitry initiates a bonus game that includes a corresponding bonus game feature. The term “bonus game feature” as used herein refers to a set of game elements, game functions, game events, parameters, and the like that enhance or otherwise change play of a bonus game. Different bonus game features may share one or more aspects (e.g., symbol array, sets of available symbols, expected value, etc.), but at least one aspect is unique to each available bonus game feature to differentiate the bonus game features. For example, one bonus game feature may be associated with an array expansion event, where the symbol array is expanded in response to detecting a reel expansion symbol in the array. Another example bonus game feature is associated with a set of persistent award events, where a persistent award is collected and applied to awards and/or value-bearing symbols. A further example bonus game feature is a hold and respin game, where symbols (e.g., value-bearing symbols) are selectively held within the symbol array.

If one trigger event (e.g., one trigger symbol) is detected and active from the base game outcomes, a bonus game instance is initiated. The bonus game instance includes a bonus game including the bonus game feature associated with the trigger event type. The bonus games are configured to have a limited duration, which may be predefined or dynamic. Dynamic durations are defined through game events and/or conditions from play of the bonus game. The duration may be defined as a number of bonus game outcomes, a period of time, and/or a number of other suitable game events detected within the bonus game. In one example, a bonus game instance having one bonus game feature active has a predefined duration of ten bonus game outcomes. The duration may be monitored through one or more stored counter variables that the game-logic circuitry monitors and updates throughout the bonus game.

In at least some embodiments, the bonus game features are configured such that at least some combinations of the available bonus game features can be implemented concurrently within a bonus game. That is, the concurrent bonus game features result in a bonus game instance that includes the unique elements of each concurrent bonus game feature. The combination of bonus game features may result in new game functionality (e.g., changing awards within a hold and respin feature based on a persistent award) within the bonus game. In certain embodiments, some combinations of bonus game features may be unavailable for concurrent play. In such embodiments, one of the bonus game features is selected for use in the bonus game, or multiple states of the bonus game are initiated.

In the example embodiment, the bonus game is a multi-state game. That is, different game functionality of the bonus game is provided in each state for a respective duration. Some of the game functionality may be shared between the bonus game states, but at least one function is distinct between states to differentiate between states. The states may be conducted in parallel or sequentially. In at least some embodiments with sequential states, an initial state of the bonus game includes at least one modifiable game element that is configured to persist between different states. For example, an initial state may add, remove, enhance, and/or other change symbol positions, available symbols, awards, free spins, and the like that are carried into the play of the second state. In some embodiments, each state of the bonus game is associated with a respective bonus game feature or combination of bonus game features. In one example as discussed with respect to the method 300, a first state is associated with a first bonus game feature, and a second state is associated with the first bonus game feature in combination with a second bonus game feature.

In at least some examples, a two-state bonus game includes a first state for modifying persistent game elements and a second state that preserves the modified persistent game elements to affect one or more award events unavailable within the first state. In other embodiments, additional or alternative states may be used, which may be defined by the bonus game feature or combination of bonus game features active within the game state.

Referring again to FIG. 5, the method 300 continues at step 304. In particular, in response to detecting a multi-state trigger event within a base game outcome, the game-logic circuitry initiates a multi-state bonus game and causes the presentation assembly to present a bonus game interface. The transition from the base game interface to the bonus game interface may be presented through one or more suitable animations and/or other visual changes, such as adding, removing, or changing one or more game and/or presentation elements.

The multi-state trigger event is associated with a plurality of bonus game features from a set of available bonus game features. In at least some embodiments, the multi-state trigger event is the combination of two or more trigger events, where each trigger event is associated with a respective bonus game feature. In one example, two different types of trigger symbols populate the base symbol array within a base game outcome, and the game-logic circuitry determines whether or not to activate a corresponding multi-state trigger event in response to detecting the trigger symbols. In a similar example, the trigger events for each trigger symbol are independently activated such that the multi-state trigger event requires both trigger events be activated.

In the example embodiment, the multi-state trigger event is associated with a first bonus game feature and a second bonus game feature. The method 300 is configured to be extended or otherwise adapted for multi-state trigger events including additional or alternative bonus game features and/or bonus games having other suitable configurations of bonus game states.

At step 306, the game-logic circuitry initiates a first state associated with the first bonus game feature and having a first duration. In the first state, the second bonus game feature is inactive and therefore the game elements and/or other game aspects uniquely associated with the second bonus game feature are not present in the bonus game for the first duration. It is to be understood that an “active bonus game feature” refers to a game feature that is actively considered by the game-logic circuitry in generating game outcomes. Conversely, the game elements, game functions, outcome determinations, awards, and the like associated with an inactive game feature are not considered by the game-logic circuitry within a game outcome. In one or more embodiments, if the multi-trigger event is associated with one or more additional bonus game features (e.g., all three coin symbols C1, C2, C3 in FIG. 4 result in a multi-state trigger event), the additional bonus game features may be active during the first state, the second state, both states, or a different state.

The first state of the bonus game includes at least one persistent modifiable game element. The modifiable game element, as described in detail herein, is configured to persist between states of the bonus game. The modifiable game element may be visually presented by the presentation assembly within the first and/or second states. The modifiable game elements include, for example and without limitation, an expandable and/or additional symbol array, persistent awards, a number of free spins or game outcomes, modifiable symbols, modifiable symbol positions, and the like.

At step 308, the game-logic circuitry is configured to generate a first bonus game outcome, and the presentation assembly is configured to present the first bonus game outcome through one or more animations and/or other suitable changes to the bonus game interface. In one example, the game-logic circuitry is configured to randomly select symbols to populate a bonus symbol array, and the presentation assembly presents a spin animation that stops on the selected symbols. The game-logic circuitry is configured to perform one or more outcome determinations based on the first bonus game outcome. At least one of the outcome determinations is based on the unique aspects of the first bonus game feature.

In the example embodiment, the first bonus game feature is associated with a modifier event available within the first state. The modifier event is any suitable game event according to the specific configuration of the first bonus state. In some examples, the modifier event includes the presence or absence of certain symbols or combinations of symbols from the first bonus game outcome. The symbol may be uniquely associated with the first bonus game feature.

At step 310, the game-logic circuitry determines whether or not the modifier is present within the first bonus game outcome. If the modifier event is detected, the game-logic circuitry is configured to update at least one of the modifiable game elements based on the modifier event at step 312. That is, the modifier event may be associated with one, some, or all of the modifiable game elements. The update to the modifiable game elements is presented through one or more suitable animations and/or updated presentation elements within the base game interface.

In one or more embodiments, the modifiable game element is the bonus symbol array. More specifically, the first bonus game feature includes a selectively expandable symbol array. The array is initiated within the first bonus state having active symbol positions and inactive symbol positions, where the inactive symbol positions are not included within any outcome determinations and may be hidden from the bonus game interface. The modifier event, which may include one or more particular expansion symbols within the first bonus game outcome, causes one or more inactive symbol positions to be converted into active symbol positions. The presentation assembly is configured to present one or more animations that visibly convey the change to the symbol array. In certain embodiments, the modifier events may also include a modifier event that reduces the size of the bonus array.

In some embodiments, the modifiable game elements include at least one persistent award. In such embodiments, the persistent award is configured to accumulate value and/or other enhancements in response to modifier events. For example, the modifier event may include value-bearing symbols, where the persistent award is updated to include or otherwise update as a function of the value visibly indicated by the value-bearing symbols. In certain embodiments, a set of available awards is available for an award selection in the second state, and the modifier event in the first state causes one or more awards to be added, removed, replaced, or enhanced.

In other embodiments, the modifiable game elements may be persistent number of extra game outcomes that are accumulated in response to the modifier events. In another example, the modifier event may cause a symbol available within both the first and second states to increase in value, modifier (e.g., a multiplier), and the like. In a further example, the modifiable game elements include one or more symbol positions associated with a modifier, award, and/or other enhancement, where the modifier events activate the enhancement of the symbol position and/or change the enhancement.

The persistent nature of the modifiable game element means the game-logic circuitry stores one or more variables associated with the game element to preserve the current state of the game element between game outcomes and, as described herein, between bonus game states. The persistence may be visually depicted through changes and/or maintaining a particular presentation within the bonus game interface, such as to the presentation elements representing the modifiable game elements.

Following step 312 or step 310 if no modifier event is detected, the game-logic circuitry determines whether or not the first duration has concluded at step 314. More specifically, the game-logic circuitry stores one or more variables for monitoring the progression of the bonus state in the first state. For example, if the duration is defined by a number of first bonus game outcomes, the game-logic circuitry stores one or more variables to monitor the current count of game outcomes relative to a termination count, where the current count is updated in response to each first bonus game outcome being generated. Other suitable variables for monitoring the progression through the first duration may be used. If the first duration has not expired, the bonus game continues within the first state for at least one additional first bonus game outcome (i.e., repeat steps 308-314).

If, however, the first duration is determined to have concluded, the game-logic circuitry is configured to initiate the second bonus state at step 316. More specifically, the second bonus state is initiated with a second duration and the second bonus game feature (which was inactive within the first bonus state) is activated. In some embodiments, the first and second bonus game features are active within the second bonus state. In other embodiments, the first bonus game feature is set to be inactive during the second bonus state. The first and/or second durations may be the same, different, or dynamically determined. In some embodiments, the total duration of the bonus game is predetermined, and the first and second durations are randomly allocated from the total duration.

The presentation assembly is configured to present a transition sequence between the first and second states to visibly convey to the player a change within the bonus game. The transition sequence may include adding new game elements for the second bonus game feature and/or removing game elements unavailable within the second bonus state.

The second state is configured to include the persistent modifiable game elements from the first bonus state. In particular, the modifiable game elements are updated throughout the first bonus state (i.e., at step 312), and any updates to the modifiable game elements are preserved into the second bonus state. In one example, the symbol array is the modifiable game element, where the modifier event causes the symbol array to include additional symbol positions. Rather than reset the symbol array to an initial state, the second bonus state is initiated with the expanded symbol array from the end of the first bonus state. In another example, the modifiable game element is a persistent award that accumulates value in response to modifier events, and the persistent award maintains the accumulated value for use within the second bonus game state (e.g., within an award provided during the second bonus game feature). In embodiments in which the first bonus game feature remains active, the modifiable game elements may still be further modified during the second bonus game state. That is, the steps 310 and 312 may be performed for the bonus game outcomes of the second bonus game state.

At step 318, the game-logic circuitry is configured to generate one or more second bonus game outcomes within the second duration based at least in part on the persistent modifiable game elements from the first bonus game state. The second bonus game outcomes include the game aspects of the second bonus game feature and, in some embodiments, the aspects of the first bonus game feature. The presentation assembly is configured to present one or more animations associated with the second bonus game outcomes, such as animations for spinning and stopping symbol-bearing reels.

In response to each second bonus game outcome, the game-logic circuitry is configured to perform one or more outcome determinations. The outcome determinations include detection of one or more game events based on the game elements comprising a given bonus game outcome. For example, at least some types of symbols may be selectively held within the symbol array, and the game-logic circuitry performs a corresponding outcome determination to detect whether any new symbols should be locked within the symbol array. The symbols held within the array may have additional functionality, such as updating a persistent award or receiving an award value from a predefined set of selectable awards. In some embodiments, the outcome determinations include determining whether or not one or more award events are present within the second bonus game outcome. The award events may include, but are not limited to, detecting particular symbols or combinations of symbols within the symbol array, randomly selecting an award from a set of awards, and the like. The available award events are based on the specific configuration of game elements associated with the second bonus game state.

The persistent modifiable game element may be associated with determining one or more award events. For example, the expandable symbol array in some embodiments provides additional symbol positions for additional symbols, thereby increasing the potential opportunities for award events. In other embodiments, the persistent modifiable game elements may not be associated with determining award events, but rather affect the award of an award event. For example, a persistent award accumulated within the first bonus game state may be awarded in response to detecting an award event within the second bonus game state.

If an award event is detected, the presentation assembly is configured to present an award sequence associated with an award of the award event. The award sequence includes one or more animations and/or visual updates to the bonus game interface that visibly convey to the player that an award was provided for the award event. For example, the award sequence may include highlighting or focusing on the game elements associated with the award event and updating one or more meters based on the value of the award.

Following the second bonus game outcomes, the second bonus game state concludes. In the example embodiment, no additional bonus game states occur, and thus the bonus game concludes. In other embodiments, the bonus game may be extended beyond two game states. In at least some embodiments, particularly embodiments with held symbols, the second bonus game state is configured to conclude with an award sequence for providing an award at least partially as a function of the values and/or modifiers indicated by the held symbols. In one example, the award values of any held value-bearing symbols are aggregated together, and any modifier associated with one or more held symbols is applied to at least one award value (e.g., the aggregate award or the award value of a single held symbol). In other embodiments, other suitable mathematical and/or logical operations are performed to generate the award associated with the concluding award sequence.

In addition to or in place of the award sequence, the presentation assembly is configured to present a transition sequence from the bonus game interface back to the base game interface (or a game interface associated with another game component of the gaming session). The transition sequence includes one or more animations that remove presentations elements associated with the bonus game and changes to base game presentation elements from the bonus game. For example, held symbols are removed from the array, and any additional symbol positions added to the symbol array are removed to return the array to a base game state. The transition sequence may also include adding presentation elements associated with the base game. Following the transition sequence, the base game is active, and the method 300 may be repeated for subsequent bonus game instances.

The following figures depict a plurality of example game interface states according to one or more embodiments of the present disclosure. In particular, the game interfaces provided herein are associated with a multi-state bonus game, where the persistent game elements are maintained through two or more of the bonus game states. In other embodiments, additional, fewer, or alternative game and/or presentation elements may be used within the game interfaces to adjust according to the particular game and/or presentation configuration desired. For example, meters (e.g., the meters 200-206 shown in FIG. 4) may be included within the game interface for monitoring a credit balance, wagers, and/or awards. The game interfaces are presented by a presentation assembly of a gaming machine (e.g., the machine 10 shown in FIGS. 1 and 2) in communication with game-logic circuitry to perform the functions described herein.

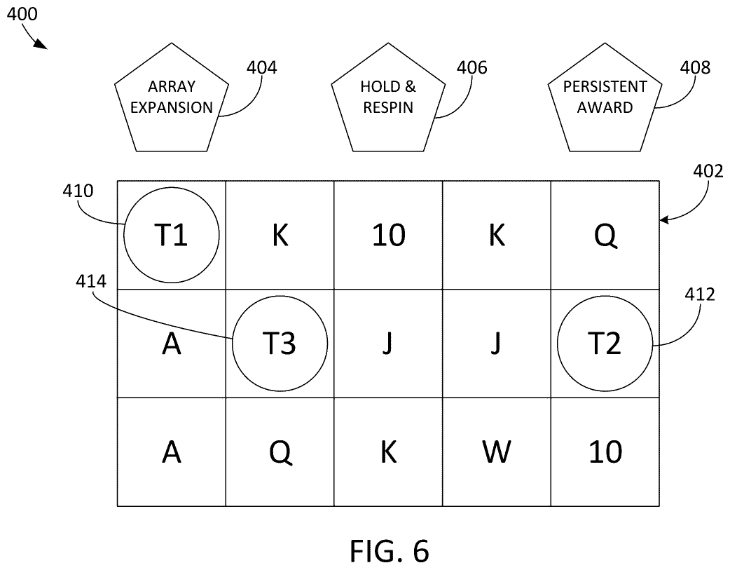

FIG. 6 depicts an example game interface 400 in a base game state. The game interface 400 includes a symbol array 402 and a plurality of persistent elements, 404, 406, 408. The symbol array 402 includes a plurality of symbol positions that are selectively populated with symbols to present a base game outcome. The symbols are randomly selected from one or more sets of available symbols (e.g., symbol-bearing reel strips). In the example embodiment, the available symbols include a plurality of trigger symbols 410, 412, 414. Each of the trigger symbols 410, 412, 414 is associated with a respective persistent element 404, 406, 408. That is, each trigger symbol 410, 412, 414 is a different type of trigger symbol associated with a different persistent element 404, 406, 408 (or different combination of persistent elements). The first trigger symbol 410 is associated with the first persistent element 404, the second trigger symbol 412 is associated with the second persistent element 406, and the third trigger symbol 414 is associated with the third persistent element 408. In some embodiments, the visual presentation of the associated trigger symbols and persistent elements is configured to visibly convey the relationship between the two game elements. For example, the presentation of the associated trigger symbols and persistent elements may include shared or supplementary visual characteristics, indicia, linking presentation elements (e.g., a line linking the two game elements together), and the like.

The persistent elements 404, 406, 408 are similar to the pots shown in FIG. 4. That is, the persistent elements 404, 406, 408 are used to provide a perceived persistence feature within the base game. The persistent elements 404, 406, 408 are associated with respective bonus game features of a bonus game that is selectively triggered from the base game. In the illustrated embodiment, each persistent element 404, 406, 408 includes indicia that visually indicates the corresponding bonus game features. Example bonus games incorporating these bonus game features are described in the following figures.

The persistent elements 404, 406, 408 are associated with corresponding trigger events for selectively initiating the bonus game. The trigger events include detecting the presence of one or more corresponding trigger symbols 410, 412, 414 within a base game outcome. In some embodiments, in response to detecting a trigger symbol in a base game outcome, the game-logic circuitry randomly determines whether or not the trigger event is active or inactive. Active trigger events cause the game-logic circuitry to initiate a bonus game and the presentation assembly to transition the game interface 400 to a bonus game interface. Determining the trigger event is inactive may result in alternative game and/or presentation changes. In one example, the presentation of the corresponding persistent element changes to grow or be enhanced in other suitable manners to facilitate a perceived persistence presentation. In another example, a credit award, modifier, and/or other suitable awards may be provided for inactive trigger events. The presentation assembly is configured to present one or more animations and/or visual changes to the interface 400 that distinguish between active and inactive trigger events. In some embodiments, each trigger event is independently determined to be active or inactive. In other embodiments, the game-logic circuitry is configured to determine all trigger events to active or inactive collectively.

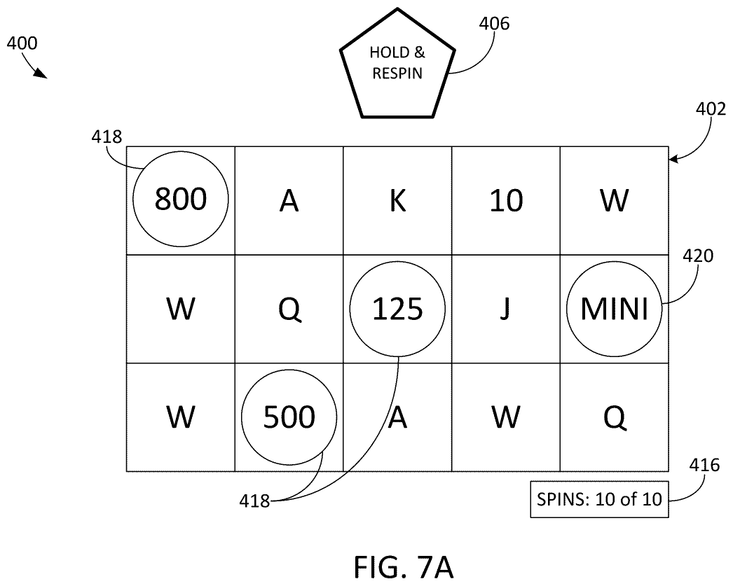

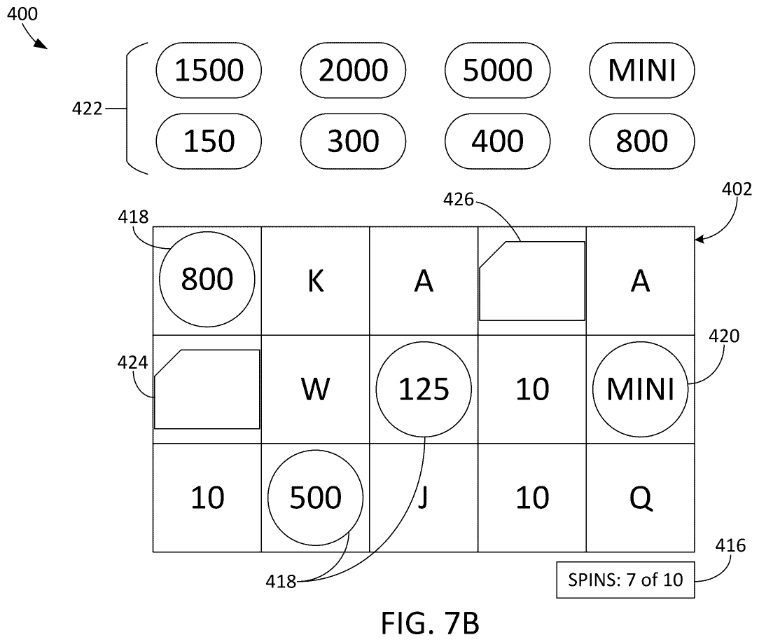

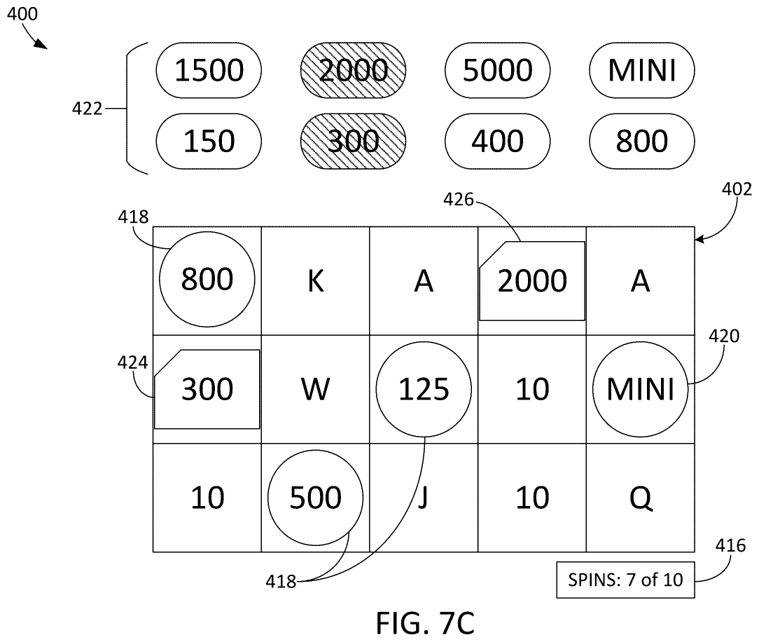

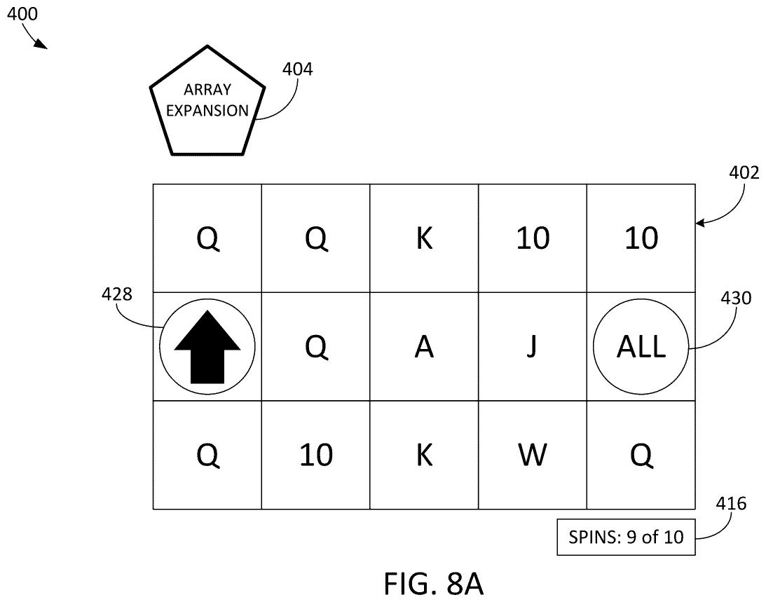

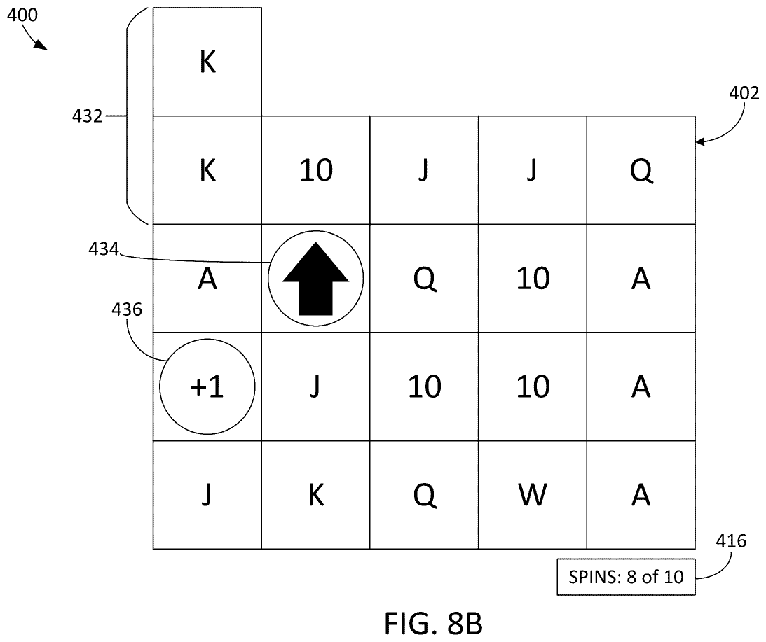

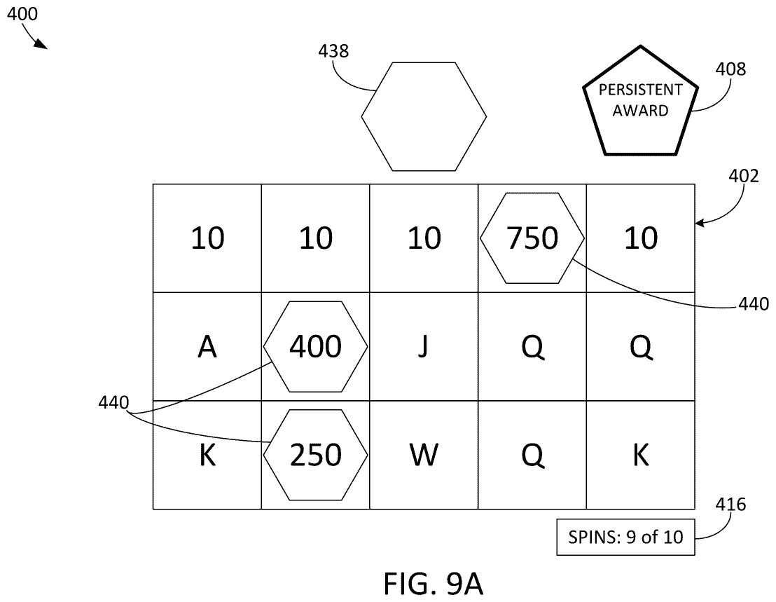

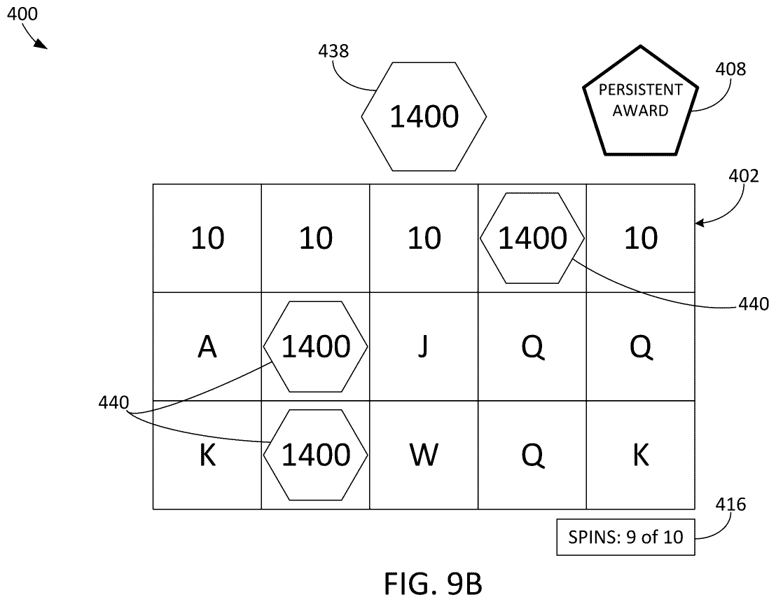

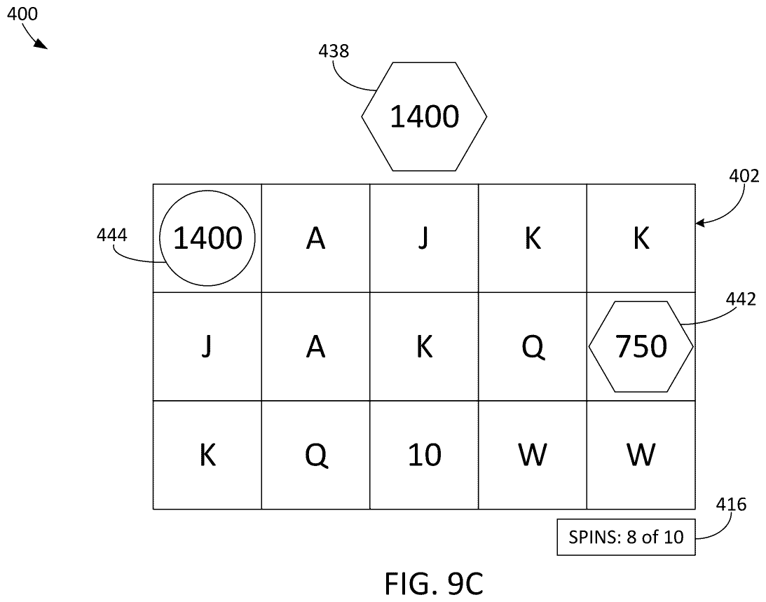

FIGS. 7A-9C depict the game interface 400 for bonus game instances having different bonus game features. More specifically, FIGS. 7A-7C depict the interface 400 for a bonus game including a hold and respin game feature associated with the second persistent element 406, FIGS. 8A and 8B depict the interface 400 for a bonus game including an array expansion game feature associated with the first persistent element 404, and FIGS. 9A and 9B depict the interface 400 for a bonus game including a persistent award game feature associated with the third persistent element 408. It is to be understood that the game features described herein are for exemplary purposes only and are not intended to limit the bonus games of the present disclosure. Rather, in other embodiments, the bonus game may include additional, fewer, or alternative available bonus game features, including those described elsewhere herein.

With respect to FIG. 7A, the trigger event associated with the second persistent element 406 is active, and a bonus game including the bonus game feature associated with the second persistent element 406 is initiated. The game interface 400 is transitioned to be a bonus game interface for play of the bonus game. In the example embodiment, the bonus game interface includes the symbol array 402 and a duration counter 416. The symbol array 402 may be substantially similar to or different from the array 402 within the base game shown in FIG. 6. In the illustrated embodiment, the symbol array 402 includes the same configuration of symbol positions (i.e., three rows and five columns). In other embodiments, the symbol array 402 has a different configuration of symbol positions relative to the base game configuration. For example, the array 402 may be expanded to include additional symbol positions at the transition to the bonus game.

In at least some embodiments, the available symbols within the bonus game may be different from the available symbols within the base game. For example, the bonus game may include special symbols uniquely associated with the bonus game features of the bonus game. In certain embodiments, one or more available symbols within both the base and bonus games may have different or additional functionality within the bonus game relative to the base game.

In the example embodiment, the available symbols include value-bearing symbols, and the bonus game outcome depicted in FIG. 7A includes several value-bearing symbols 418. The value-bearing symbols 418 are configured to be locked or held within the symbol array 402 for the remainder of the bonus game or another suitable award event is detected. In addition to the value-bearing symbols 418, which have award indicia visibly indicating an award value associated with the respective symbol 418, the bonus game outcome includes a value-bearing symbol 420 associated with a progressive jackpot. That is, rather than having award indicia directly indicating the award value associated with the value-bearing symbol, the award indicia indicates to a progressive jackpot identity (e.g., “MINI,” “MINOR,” “MAJOR,” “GRAND,” etc.) having the award value of the value-bearing symbol 420.

In the illustrated embodiment shown in FIG. 7A, the symbol positions are populated with several different types of symbols, including value-bearing symbols. The game-logic circuitry, through all or some instances of the bonus game, may be configured to perform outcome determinations associated with detecting any winning symbol combinations within a bonus game outcome, such as according to scatter or pay line rules associated with reel-based gameplay. In other embodiments, one or more symbol positions may remain “blank” or empty within a bonus game outcome. In such embodiments, the sets of available symbols may include “blank” symbols available for selection for a bonus game outcome. In one example, the available symbols are limited to lockable symbols, such as value-bearing symbols and modifier symbols. In another example, certain modifier symbols (e.g., modifiers affecting the duration of the bonus game) are available without being locked within the array 402. In certain embodiments, inactive symbols may populate the symbol array 402, where the inactive symbols are ignored during bonus game outcome determinations. Similar outcome configurations including standard symbols are illustrated herein, and it is to be understood the game-logic circuitry may perform one or more outcome determinations associated at least with these symbols.

In addition to the new symbols and outcome determinations associated with the symbols (e.g., detecting and locking value-bearing symbols within the array 402), a duration of the bonus game is defined and presented via the duration counter 416. The duration may be static or dynamic, where a dynamic duration is adjusted in response to game events occurring within the bonus game. In the example embodiment, the duration counter 416 is initiated to a value of ten and is configured to decrement in response to each bonus game outcome towards a termination count or value (e.g., zero). Other suitable duration presentations may be used to monitor the remaining duration of the bonus game. For example, the duration counter 416 may be animated to increment from zero to ten, and/or approaching the termination count causes one or more other presentation elements (e.g., the symbol array 402) to change in appearance to indicate to the player that the bonus game is concluding. In certain embodiments, the duration counter 416 is hidden from the game interface 400 for at least a portion of the bonus game.

In the example embodiment, the bonus game with the hold and respin bonus game feature is configured to include a plurality of bonus game outcomes, where any value-bearing symbols detected within the bonus game outcomes are held within the symbol array 402. At the conclusion of the bonus game duration, the presentation assembly is configured to present (e.g., via the game interface 400) an award sequence for an award at least partially as a function of the held symbols. In one example, the award is a function of any held modifiers and an aggregate value of the held value-bearing symbols. In another example, the award is based on a subset of the held symbols. In such an example, the subset may be randomly selected or selected based on predefined selection parameters, such as selecting the five value-bearing symbols having the highest values. In certain embodiments, other award events may be available prior to the conclusion of the bonus game such that the locked symbols are awarded and removed from the array 402, thereby facilitate new symbols to populate the previously occupied positions. For example, an aggregation symbol may aggregate the value of all held value-bearing symbols prior to the award sequence at the conclusion of the bonus game.

FIGS. 7B and 7C depict the game interface 400 within one example hold and respin bonus game feature. More specifically, FIGS. 7B and 7C depict a selection sequence associated with the hold and respin bonus game feature. In the example embodiment, in addition to the value-bearing symbols 418, 420 held within the array 402, the hold and respin bonus game includes a plurality of selectable awards 422 presented separate from the array 402. The bonus game feature includes an award selection trigger for selecting awards from the selectable awards. In the example embodiment, the award selection trigger includes detecting any award symbols within a bonus game outcome. In other embodiments, the award selection trigger includes additional or alternative game events or conditions detectable by the game-logic circuitry from a bonus game outcome.

The selectable awards 422 may be a predetermined set of awards, selected from a wider set of available awards, randomly generated or selected based on one or more predefined parameters (e.g., each award is selected from a range or set of values), and/or other suitable grouping of awards. In one example, a subset of the awards 422 are predefined (e.g., any progressive jackpot awards), while the remaining awards 422 are randomly selected from a set of available awards.

In FIG. 7B, the bonus game outcome includes two award selection symbols 424, 426. For each award selection symbol 424, 426, an award is randomly selected from the selectable awards 422, and the presentation assembly presents a corresponding selection sequence including one or more animations and/or other visual changes to the interface 400 that visibly convey which award was selected for which award selection symbol 424, 426. In some embodiments, one award is selected for both award selection symbols 424, 426.

In the example embodiment, the selected award is applied to the corresponding award selection symbols 424, 426, and the award selection symbols 424, 426 are held within the symbol array 402 similar to the value-bearing symbols 418, 420. The application of the awards includes presenting and/or updating award indicia for the award selection symbols 424, 426 to indicate the selected awards. In certain embodiments, at least some award symbols may be associated with modifiers, where the award indicia of a given award symbol indicates an award determined at least partially as a function of the selected award and the respective modifier.

FIG. 7C depicts the result of a selection sequence from the award selection trigger detected in FIG. 7B. More specifically, respective awards from the selectable awards 422 were selected and applied to the award selection symbols 424, 426. In the example embodiment, some or all of selectable awards are available for selection once within the bonus game such that the selected awards are removed from any subsequent selection sequences. In the illustrated embodiment, the selected awards are visually distinguished from the remaining selectable awards 422 to visibly convey to the player that the selected awards are no longer available. Other suitable visual distinctions between the selectable awards 422 and unavailable awards may be used, including removing the unavailable awards from the interface 400 altogether.

Turning now to FIGS. 8A and 8B, the game interface 400 is a bonus game interface for a bonus game including the bonus game feature associated with the first persistent element 404. More specifically, the bonus game feature is an array expansion game feature, where the symbol array 402 is configured to selectively include additional symbol positions.

The bonus game with the array expansion game feature includes the symbol array 402. In some embodiments, the symbol array 402 is initiated in the same configuration as the base symbol array 402 shown in FIG. 6. In other embodiments, the symbol array 402 may be initiated in a different configuration (e.g., different number of symbol positions, rows, columns, etc.) for the bonus game. The symbol array 402 is associated with a plurality of inactive symbol positions that are hidden from the game interface 400 or are presented in a visually distinct inactive state. The inactive symbol positions are ignored during the generation of bonus game outcomes and/or the corresponding outcome determinations. The inactive symbol positions in combination with the symbol array 402 may collectively define a maximum symbol array, where the symbol array 402 (sometimes referred to as the “active symbol array 402”) can be expanded up to the maximum symbol array.

In the example embodiment, the bonus game outcomes include selectively populating the symbol array 402 with symbols. The symbols may be randomly selected from one or more sets of available symbols associated with the array expansion game feature. The array expansion game feature includes one or more array expansion triggers based at least partially on the available symbols. That is, in response to the game-logic circuitry detecting an array expansion trigger, the active symbol array 402 is configured to expand to include one or more additional symbol positions. The array expansion may persist through the bonus game or persist for a portion of the bonus game. In at least some embodiments, the array expansion trigger includes detecting one or more symbols within a bonus game outcome that are associated with the array expansion game feature. In certain embodiments, the array expansion game feature may include additional or alternative triggers for manipulating the symbol array 402. For example, certain triggers may cause symbol positions to be removed from the array 402 or the symbol positions of the array 402 to be rearranged.

FIG. 8A depicts the game interface 400 with a first bonus game outcome associated with the array expansion game feature. The array 402 is selectively populated symbols, which include a first expansion trigger symbol 428 and a second expansion trigger symbol 430. The expansion trigger symbols 428, 430 are associated with respective array expansion triggers, thereby causing the game-logic circuitry and the presentation assembly to present an expansion sequence. More specifically, in response to one or more array expansion triggers, one or more inactive symbol positions are activated and added to the symbol array 402.

The expansion trigger symbols 428, 430 have different effects on the array expansion as indicated by the different indicia shown within the symbols 428, 430. More specifically, the first expansion trigger symbol 428 is configured to expand the column occupied by the symbol 428, while the second trigger symbol 430 is configured to expand all of the columns of the array 402. In some embodiments, additional or alternative array expansion trigger symbols may be used. For example, one array expansion trigger symbol may allocate one to five additional symbol positions to any of the columns. In another example, multiple column expansion trigger symbols may be available to expand a given column by one or more positions.

The array expansion sequence includes one or more animations and/or visual changes to the interface 400 to visibly convey the change to the symbol array 402. For example, an animation may be used that causes the additional symbol positions to “expand” or extend from the preexisting symbol array 402. The array expansion sequence may be performed independently for each detected array expansion trigger, or the sequence may be blended together for all of the array expansion triggers.

FIG. 8B depicts the game interface 400 following the array expansion sequence based on the array expansion trigger detected in FIG. 8A. More specifically, the game interface 400 in FIG. 8B depicts a subsequent bonus game outcome including new symbols populating the array 402.

The array 402 has been expanded to include additional symbol positions 432 in response to the array expansion trigger symbols 428, 430 shown in FIG. 8A. More specifically, the leftmost column expanded to include two new symbol positions based on both of the trigger symbols 428, 430, while the remaining columns expanded to include one additional position based on the second trigger symbol 430. The additional symbol positions 432 are available for use within bonus game outcomes following the array expansion sequence, such as the bonus game outcome shown in FIG. 8B. The state of the symbol array 402 may be configured to persist until a subsequent array expansion trigger event and/or the bonus game concluding. In other embodiments, the symbol array 402 may be configured to reset or revert in response to other suitable game events or conditions associated with the bonus game.

In the example embodiment, the bonus game outcome shown in FIG. 8B includes another array expansion trigger symbol 434 and an additional outcome symbol 436. The array expansion trigger symbol 434, when detected by the game-logic circuitry, causes a subsequent array expansion sequence to add one or more additional symbol positions to the associated column (i.e., the second column from the left) similar to the first array expansion trigger symbol 428 shown in FIG. 8A.

In the example embodiment, the columns or other suitable subsets of positions within the array 402 are configured to expand up to a predetermined maximum number of symbol positions defined by the maximum symbol array. If an array expansion trigger is detected for a subset or column that can no longer be expanded, the array expansion trigger may be converted to award an additional bonus game outcome. In other embodiments, the game-logic circuitry converts the symbols or other game elements associated with the array expansion trigger for a subset of the symbol array 402 having reached a maximum expansion prior to detection. In the example embodiment, the additional outcome symbol 436 is configured to replace a corresponding array expansion trigger symbol from the set(s) of available symbols. In certain embodiments, the additional outcome symbol 436 still appears as an array expansion symbol but has a different effect on the bonus game.

The additional outcome symbol 436 causes the duration of the bonus game to be extended by one or more bonus game outcomes. For example, instead of decrementing the remaining count shown by the duration counter 416 is response to the bonus game outcome shown in FIG. 8B, the current count may remain the same, thereby extending the duration by one. In some embodiments, for multi-state bonus games having multiple durations as described herein, the additional bonus game outcomes may be added to a different bonus game state.

FIGS. 9A-9C depict the game interface 400 as a bonus game interface for a bonus game including the bonus game feature associated with the third persistent element 408. More specifically, the bonus game feature associated with the third persistent element 408 includes a persistent award that is updated in response to certain game events and awarded through one or more award events detected within the bonus game outcomes. The game interface 400 includes the symbol array 402, which may have the same, similar, or different configuration relative to the symbol array 402 within the base game and/or other bonus game features. The symbol array 402 is selectively populated with symbols randomly selected from one or more sets of available symbols. The sets of available symbols include one or more symbols uniquely associated with the bonus game feature of the third persistent element 408 and/or symbols having certain functionality that is uniquely active within the bonus game feature of the third persistent element 408. That is, a symbol shared between other bonus game features and/or the base game may be configured to include new functionality associated with the bonus game feature described herein in some embodiments.

In addition to the symbol array 402, the game interface includes an award element 438 presented external to the array 402. The award element 438 is associated with a persistent award that is accumulated and awarded through the bonus game. The award element 438 is configured to include award indicia and/or other visual characteristics to visibly convey the persistent award within the interface 400. With respect to FIG. 9A, the award element 438 is depicted with no award indicia because the award element 438 is in an initial state having a value of zero. As can be seen in FIG. 9B, where the award element 438 accumulates a non-zero award value as described herein, award indicia is presented. In some embodiments, the persistent award is initiated at a non-zero value, and the award element 438 includes award indicia to reflect the value of the persistent award.

FIG. 9A depicts the game interface 400 with a first bonus game outcome for the persistent award game feature. The symbol array 402 is populated with randomly selected symbols and includes three award symbols 440. The award symbols 440 are associated with an award accumulation event associated with the persistent award of the award element 438. That is, in response to detecting one or more award symbols 440 within the bonus game outcome, the game-logic circuitry triggers the award accumulation event.

The award accumulation event is configured to increase, enhance, or otherwise update the persistent award of the award element 438. In at least some embodiments, the award accumulation event is configured to update the persistent award for each award symbol 440 detected in the bonus game outcome. In the illustrated embodiment, the persistent award is updated three times based on the three award symbols 440. In some embodiments, the award symbols 440 are value-bearing symbols, and the award accumulation event includes aggregating the award values of the award symbols 440 to update the persistent award. In other embodiments, the award values are not stored by the award symbols 440, but rather the award accumulation event includes other suitable presentations of the updates to the persistent award, including presentations in which the new value of the persistent award is revealed without presenting the values added to the persistent award. In one example, each update to the persistent award within an award accumulation event causes the persistent award to increase by a predetermined value. Other suitable mathematical and/or logical operations may be used to change the persistent award through an award accumulation event. In certain embodiments, the persistent award is not limited to credit values, but may additionally or alternatively include other suitable game awards and enhancements (e.g., extra bonus game outcomes, multipliers, modifiers, jackpot triggers, etc.).

In the example embodiment, the award accumulation event includes aggregating the award values of the award symbols 440 and applying the aggregated award value to the award element 438. The presentation assembly is configured to present one or animations and/or other suitable visual updates to the game interface to depict the value accumulation by the award element 438. For example, for each update to the persistent award, the award element 438 is animated to reveal the new value of the persistent award. In at least some embodiments, the award accumulation event includes an award sequence providing an award based on the new value of the persistent award. In one example, the persistent award is provided for each award accumulation event. In another example, the persistent award feature includes an award sequence for any value-bearing symbols within the array 402, and the persistent award is applied to each award symbol 440 through the award accumulation event to indirectly award the persistent award. Other suitable presentations and methods of awarding the persistent award may be used according to the particular configuration of the game interface 400 and the bonus game.

FIG. 9B depicts the game interface 400 following the award accumulation event triggered in FIG. 9A. The award values from the award symbols 440 were accumulated by the persistent award and the updated persistent award is reflected by the award indicia of the award element 438. In this example, awards are provided for any value-bearing symbols in the array 402 at the conclusion of the bonus game outcome, and the award accumulation event includes updating each of the award symbols 440 with the updated persistent award value. In other embodiments, the persistent award is awarded directly without incorporating the award symbols 440, or the award values of the award symbols 440 remain unchanged based on the persistent award.

FIG. 9C depicts the game interface 400 including a second bonus game outcome following the outcome shown in FIGS. 9A and 9B. The second bonus game outcome includes a new set of symbols populating the symbol array 402, and the new symbols include a new award symbol 442 and a value-bearing symbol 444.

The new award symbol 442, similar to the award symbols 440 shown in FIGS. 9A and 9B, causes an award accumulation event to be triggered to update the persistent award indicated by the award element 438. The award element 438 is configured to store the value of the persistent awards across bonus game outcomes such that the update to the persistent award is a function of the preexisting value of the persistent element. For example, following the state shown in FIG. 9C, the value indicated by the award symbol 442 is applied to the preexisting value indicated by the award element 438 during the award accumulation event. The persistent award may be configured to persist for the duration of the bonus game and/or the duration of the persistent award game feature.

In the example embodiment, the persistent award game feature includes one or more means of awarding the persistent award. For example, at least some award accumulation events include providing an award at least partially based on the persistent award. In another example, some symbols associated with award events within the bonus game may be configured to include the persistent award or otherwise include an award value based at least partially on the persistent award. The value-bearing symbol 444 is configured to include the current value of the persistent award as award indicia, and the example persistent award game feature includes an award event for any value-bearing symbols detecting within the symbol array 402. In some embodiments, the value of the value-bearing symbol 444 may be selectively updated in response to any concurrent award accumulation events detected within the bonus game outcome (i.e., the presence of the award symbol 442).

The persistent award game feature may include other suitable value-bearing symbols untethered to the persistent award unlike the award symbols 440, 442 and the value-bearing symbol 444. In such embodiments, the value-bearing symbol 444 includes one or more visual characteristics to visually distinguish from other types of value-bearing symbols. In some embodiments, the value-bearing symbols are not initially associated with the persistent award, but rather the persistent awards are randomly applied to one, some, all, or none of the value-bearing symbols detected within a bonus game outcome.

The bonus game features described above with respect to FIGS. 7A-9C are configured to be selectively implemented concurrently within a bonus game. That is, the symbols, game events, changes to the game elements, and the like associated with each bonus game feature may be blended together within a bonus game instance. For example, one bonus game instance may include both the array expansion game feature shown in FIGS. 8A and 8B and the persistent award game feature shown in FIGS. 9A-9C by including the array expansion trigger symbols, award symbols, expandable symbol array, persistent award, and other corresponding game and/or presentation elements that facilitate the functionality of each game feature. In certain embodiments, some combinations of game features may be restricted (e.g., game features within incompatible game elements and changes to the game interface) or result in an altered combination of the game features partially different from the underlying game features. For example, the hold and respin game feature combined within the persistent award game feature may implement the persistent award as one or more selectable awards (e.g., the selectable awards 422 shown in FIGS. 7B and 7C).

Additionally or alternatively, the bonus game is configured to be conducted within a plurality of bonus game states. The bonus game states are distinct from each other through different active game features. In one example, a first bonus game feature is active during a first bonus game state, and a second bonus game feature is active during a second, subsequent bonus game state. In another example, the first bonus game state includes a first bonus game feature, and the second bonus game state includes the combination of the first bonus game feature with a second bonus game feature. While some bonus game states may be entirely independent of other bonus game states, at least a portion of the bonus game states are configured to share one or more modifiable game elements such that changes in a first bonus game state persist or are carried into the second bonus game state. The modifications from the first bonus game state facilitate, directly or indirectly, changes to the game features of the second bonus game state.

In one example, a bonus game instance includes a first bonus game state including an array expansion game feature and a second bonus game state including the array expansion game feature in combination with a hold and respin game feature. During the first bonus game state, similar to the game feature described in FIGS. 8A and 8B, the symbol array is selectively expanded to include additional symbol positions. After the duration of the first bonus game state has concluded, the second bonus game state is initiated while preserving the state of the symbol array from the end of the first bonus game state. During the second bonus game feature, the game aspects from the array expansion game feature may continue to affect the size and configuration of the symbol array. The hold and respin game feature, in contrast to bonus game instances without the array expansion game feature, advantageously has access to additional symbol positions to be filled with value-bearing symbols, thereby potentially increasing the value and/or opportunities to receive additional awards from the hold and respin game feature.

In another example, a bonus game instance includes a first bonus game state including a persistent award game feature and a second bonus game state including the persistent award game feature in combination with a hold and respin game feature. Play of the first bonus game state may be similar to the gameplay described with respect to FIGS. 9A-9C. At the end of the first bonus game state, the value of the persistent award is preserved and carried into the second bonus game state. During the second bonus game state, in contrast to the first bonus game state, the value-bearing symbols associated with the persistent award are held within the symbol array. Accordingly, changes to the persistent award are not merely applied to new value-bearing symbols from a given second bonus game outcome, but rather all or some held value-bearing symbols associated with the persistent award are updated as well, thereby increasing a potential value of the award provided for the hold and respin game feature.

In certain embodiments, some multi-state bonus games include bonus game features that are not independently available because such bonus game features rely upon the specific game elements and game events of another supplemental game feature. For example, the hold and respin game feature may be paired with a supplemental bonus game feature that includes game events affecting the set of the selectable awards within the hold and respin game feature. In such an example, the game events may add, remove, enhance, replace, or otherwise change one or more awards of the set of selectable awards for play of the hold and respin game feature in a subsequent bonus game state. In another example, a bonus game feature paired with the array expansion game feature may selectively apply modifiers to one or more symbol positions added to the symbol array through the array expansion game feature.

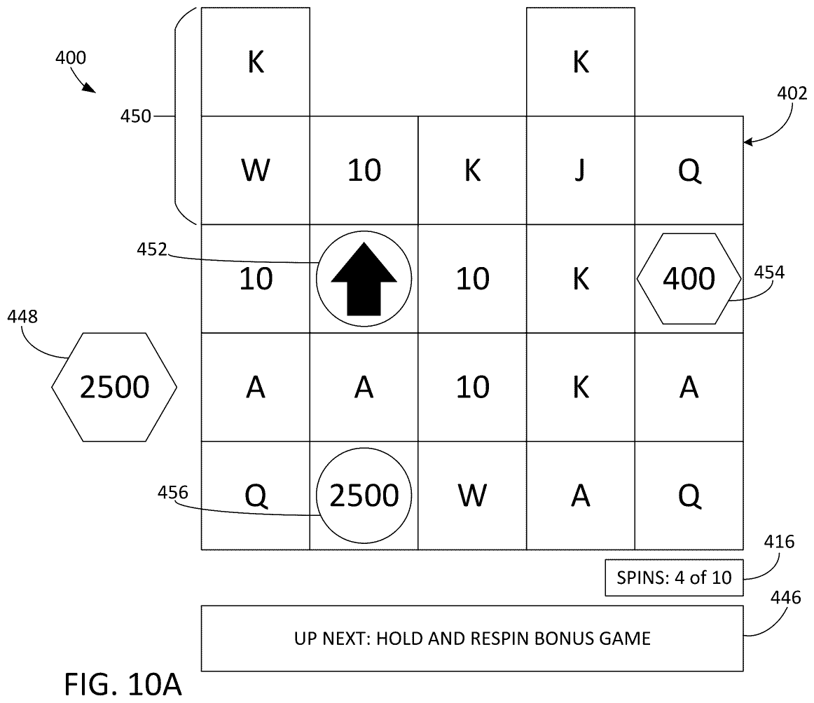

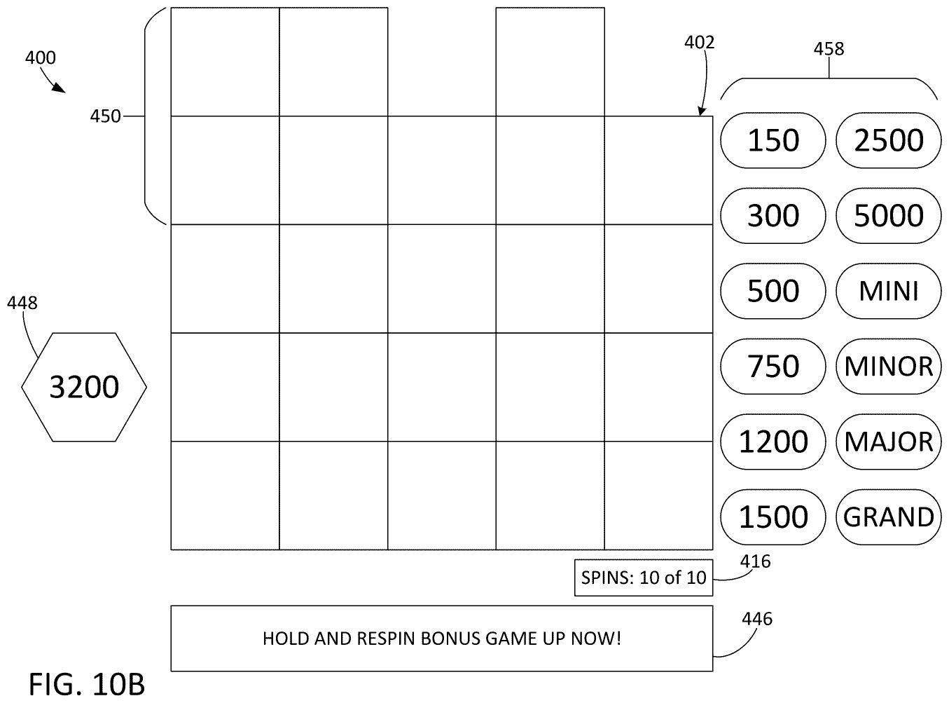

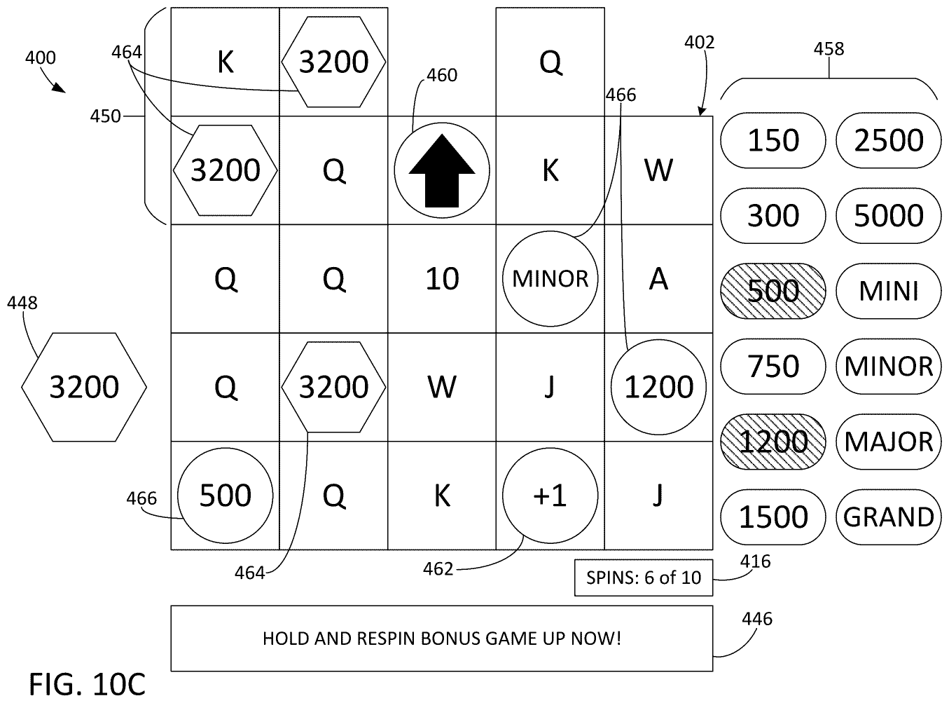

FIGS. 10A-10C depict the game interface 400 for a multi-state bonus game including the three game features shown in FIGS. 7A-9C. More specifically, the multi-state bonus game is triggered in response to the multi-state trigger event shown in FIG. 6. The multi-state bonus game includes two bonus game states. The first bonus game state incorporates an array expansion game feature and a persistent award game feature. The second bonus game state following the first bonus game state includes the array expansion and persistent award game features in combination with a hold and respin game feature.

A multi-state trigger event is a trigger event associated with two or more bonus game features compatible for a multi-state bonus game. Referring back to FIG. 6, the multi-state trigger event includes the presence of three types of trigger symbols 410, 412, 414, each of which are associated with a respective persistent element 404, 406, 408 and corresponding bonus game features. In at least some embodiments, the multi-state trigger event may include one or more random determinations by the game-logic circuitry to determine whether or not a bonus game shown be triggered based on one, some, or all of the trigger symbols 410, 412, 414. In some embodiments, a single random determination is used to determine whether or not the bonus game is initiated. In other embodiments, a random determination is performed for each trigger symbol 410, 412, 414 or for each type of trigger symbol such that a bonus game can be initiated with less than all of the bonus game features associated with the trigger symbols 410, 412, 414.

In response to initiating the bonus game, the first bonus game state begins with the array expansion game feature and the persistent award game feature active. Accordingly, the available set(s) of symbols used within the first bonus game state include any symbols associated with these game features (e.g., array expansion trigger symbols, award symbols, etc.). The array expansion and persistent award game features are configured to be conducting concurrently within the bonus game such that the game-logic circuitry performs certain outcome determinations for each game feature in response to a bonus game outcome.

FIG. 10A depicts the game interface 400 for the bonus game in the first bonus game state. The game interface 400 includes the symbol array 402, the duration counter 416, a notification box 446, and an award element 448 associated with a persistent award. In other embodiments, the game interface 400 includes additional, fewer, or alternative game and/or presentation elements, including elements described elsewhere herein.

The game interface 400 is shown after several bonus game outcomes have been generated and presented, and changes to the modifiable game elements (e.g., the symbol array 402 and the persistent award) have occurred. That is, the symbol array 402 has expanded to include a plurality of additional symbol positions 450 through array expansion events, and the persistent award has been updated to accumulate award values in response to one or more award accumulation events. In addition to the prior game events, the bonus game outcome shown in FIG. 10A includes several new game events affecting or otherwise incorporating the modifiable game elements. For example, an array expansion trigger symbol 452 occupies a second column of the array, and, in response, the second column will expand to include another symbol position. The symbols occupying the array 402 further include an award symbol 454, which triggers an award accumulation event to update the value of the persistent award, and a value-bearing symbol 456 configured to receive the current value of the persistent award.

The notification box 446 is presented through the first bonus game state to visibly indicate to the player that a second, subsequent bonus game state is to follow. In the example embodiment, the notification box 446 indicates the hold and respin game feature, which is inactive during the first bonus game state, will be next. Other suitable messages and/or other presentation elements may be used to notify the player of the second bonus game state.

FIG. 10B depicts the game interface 400 at the initiation of the second bonus game state. That is, the duration of the first bonus game state (which may be indicated by the duration counter 416) has concluded, and the second bonus game state is presented. The presentation assembly is configured to present a transition sequence between bonus game states including one or more animations to change, add, or remove presentation elements from the interface 400.

In the example embodiment, the first bonus game state is associated with the array expansion and persistent award game features. Throughout the first bonus game state, these game features modify the symbol array 402 and a persistent award indicated by the award element 448 in response to modifier events, and the game interface 400 is updated accordingly. These modifiable game elements are configured to persist into the second bonus game state with the updates from the first bonus game state. The symbol array 402 and the persistent award shown in FIG. 10B represent the state of the array 402 and the persistent award at the conclusion of the first bonus game state, which includes any additional symbol positions and accumulation award value, respectively.

In addition to the modifiable game elements, the game interface 400 is configured to include any additional game and/or presentation elements associated with any newly active game features for the second bonus game state. In the example embodiment, the second bonus game state includes a hold and respin game feature that was inactive during the first bonus game state, and the game interface includes a set of selectable awards for the game functionality associated with the hold and respin game feature (e.g., the functionality described with respect to FIGS. 7A-7C).

The duration counter 416 is configured to be updated to reflect a second duration associated with the second bonus game. That is, in FIG. 10A, the duration counter 416 monitored a first duration associated with the first bonus game state. Reaching the termination count (e.g., in the illustrated example, zero) in the first bonus game state causes the bonus game to transition to the second bonus game state. In the second bonus game state, because no other bonus game states remain, the conclusion of the second duration as monitored by the duration counter 416 causes the bonus game to conclude and return to the base game or other suitable game. In certain embodiments, the duration counter 416 monitors a total duration of the bonus game, and the transition between the first and second bonus game states may be monitored through other suitable presentation elements and/or additional counters.

In the example embodiment, the second bonus game state not only includes the hold and respin game feature similar to the feature described with respect to FIGS. 7A-7C, but also includes the array expansion and persistent award game features continuing from the first bonus game state. That is, the available symbols for populating the symbol array 402 include symbols associated with all three game features, and the game-logic circuitry is configured to perform outcome determinations for each of the game features. Additionally, the modifiable game elements, i.e., the symbol array 402 and the persistent award, are further modifiable within the second bonus game state.

FIG. 10C depicts the game interface 400 for an example bonus game outcome of the second bonus game state. The game interface 400 includes one or more game elements and/or updated game elements from game events detected in the bonus game outcome and prior bonus game outcomes from the second bonus game state. More specifically, the symbol array 402 includes an array expansion trigger symbol 460, an additional outcome symbol 462, a plurality of award symbols 464, and a plurality of award selection symbols. One or more of the symbols may be held within the symbol array 402 from a prior bonus game outcome.

The array expansion trigger symbol 460 and the additional outcome symbol 462 may operate similar to the corresponding symbols shown in FIGS. 8A and 8B. Any symbol positions added through the array expansion game feature may be used in any remaining bonus game outcomes. The award symbols 464 are associated with the persistent award. In the example embodiment, the award symbols 464 are updated within the persistent award to include a matching award value. Unlike the persistent award game feature shown in FIGS. 9A-9C, the award symbols 464 are held within the symbol array 402 such that any subsequent changes to the persistent award 448 (e.g., a new award symbol is detected in the next game outcome) are carried to the held award symbols 464. In some embodiments, the value of the held award symbols remains the same irrespective of any changes to the persistent award in subsequent game outcomes.

The award selection symbols 466 are associated with the hold and respin game feature. That is, the award selection symbols 466 are initially presented without award indicia, and the game-logic circuitry is configured to select an award from the selectable awards to be linked to each symbol 466. In the example embodiment, each credit award is linkable to a single award selection symbol 466, and the game interface 400 includes a visual distinction between previously selected and available awards (including removal of the selected awards from the interface 400). The progressive jackpot awards, however, are available for multiple selections as can been seen in the visual difference between the selectable award for the “MINOR” progressive jackpot and the two previously selected credit awards. In other embodiments, all of the selectable awards are selectable once or can be selected a plurality of times, including an unlimited number of times. In certain embodiments, other alternative configurations include a different combination of single-selection and multiple-selection awards.

The second bonus game state is configured to continue with subsequent bonus game outcomes for the remaining duration. At the conclusion of the second bonus game state, an award sequence is presented by the presentation assembly for any held symbols within the symbol array 402. As there are no remaining bonus game states, the bonus game concludes and returns to the base game. The presentation assembly is configured to present a transition sequence (which may be integrated with the award sequence) that includes animations for removing the held symbols from the symbol array 402, removing the presentation elements external to the array 402 (e.g., the duration counter 416, notification box 446, award element 448, and awards 458), returning the symbol array 402 to a base game state, and otherwise adding or removing presentation elements for subsequent play of the base game.

Although the example provided above with respect to FIGS. 10A-10C depicts a two-state bonus game, it is to be understood that other suitable multi-state bonus games may be used. For example, the array expansion and persistent award game features may be performed in separate game states. In another example, a third bonus game state follows the second bonus game state, where the third bonus game state only includes the hold and respin game feature. The multi-state bonus game may include additional or alternative bonus game states, including those described elsewhere herein. In one example, the hold and respin game feature is active in the first bonus state, while the array expansion and/or persistent award feature are active in the second bonus game state.

At least some embodiments of the present invention comprise an innovative application of data processing steps that, when implemented by game-logic circuitry, direct a presentation assembly to present array modification, symbol-value collection, symbol or prize selection, and award processes that minimize processing overhead by utilizing numbered indicia to represent credit values and other streamlined game and presentation elements instead of complex, fanciful game images. In this way, the value-bearing symbols, dynamic array, and award elements described herein provide building blocks for innumerable different collection, adjustment, and selection sequences simply by manipulating the criteria associated with the value-bearing symbols and award elements, resulting in fewer rules needed for the award process than would be necessary for calculating values of winning symbol combinations enumerated in stored paytables, as found in prior art reel-spinning routines. At the same time, embodiments of the present invention provide a straightforward, what-you-see-is-what-you-get (WYSIWYG) visual presentation that is simple to understand and, therefore, effective in generating player excitement and enthusiasm. The result is a highly flexible value-award process that can be easily adapted to any theme/brand while remaining easily understood by players.

With respect to the hold and respin game feature, as prize and upgrade symbols land and are held in the bonus game array, the game-logic circuitry need only respin those reels associated with any remaining vacant positions in the array. This minimizes the contribution of reels spins to processing overhead. And because the game-logic circuitry needs only to evaluate the bonus game array for completed matches of prize symbols, the computing resources for conducting the game feature itself are minimized. In stark contrast, in typical free spin bonuses, overlapping payline sections require multiple evaluation steps. Often, analysis is required to determine which payline results in the highest credit total, with the lesser value paylines being discarded but only after being evaluated-all this adds to processing overhead. Special symbols like wilds, multipliers, and scatter symbols can modify paytable values and may require separate, additional evaluation according to customized rule sets. All these procedures can be inherently more complex than the bonus game embodiments disclosed herein. The embodiments disclosed herein involve simple collection and aggregation of held prize symbols. This represents a win-win: simpler, almost self-explanatory graphics combined with faster, more efficient processing.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming machine comprising:
a presentation assembly configured to present a gaming session comprising a base game and a multi-state bonus game including a first bonus game feature and a second bonus game feature; and
game-logic circuitry in communication with the presentation assembly, the game-logic circuitry configured to:
conduct the base game by:
causing the presentation assembly to present a base game interface including a plurality of symbol-bearing base reels, a base array, and a plurality of persistent elements including a first persistent element associated with the first bonus game feature and a second persistent element associated with the second bonus game feature;
causing the presentation assembly to spin and stop the plurality of base reels to land symbols from the base reels in the base array; and
in response to the landed symbols including a feature-triggering symbol associated with the first persistent element and a feature-triggering symbol associated with the second persistent element:
animating an addition of the feature-triggering symbol to the associated persistent element via the presentation assembly; and
randomly determining whether or not to trigger the first bonus game feature and the second bonus game feature;
in response to triggering the first bonus game feature and the second bonus game feature, conduct the bonus game with the first bonus game feature for a first duration, the second bonus game feature being inactive during the first duration, wherein the bonus game within the first duration includes:
causing the presentation assembly to present a bonus game interface including a plurality of symbol-bearing bonus reels and a bonus array, the bonus game interface including one or more modifiable game elements associated with the first bonus game feature;
causing the presentation assembly to present one or more first bonus game outcomes by spinning and stopping the plurality of bonus reels to land symbols from the bonus reels in the bonus array; and
in response to detecting the one or more first bonus game outcomes including a modifier event of the first bonus game feature, updating, via the presentation assembly, at least one of the one or more modifiable game elements based on the modifier event, wherein the modifier event is inactive within the base game; and
in response to the first duration concluding, conduct, for a second duration, the bonus game with the second bonus game feature and the at least one updated modifiable game elements from the first bonus game feature by causing the presentation assembly to present, via the bonus game interface, one or more second bonus game outcomes based on the second bonus game feature and the at least one updated modifiable game elements.

2. The gaming machine of claim 1, wherein the bonus game includes a first bonus game state for the first duration and a second bonus game state for the second duration, and wherein the first bonus game feature continues in combination with the second bonus game feature within the second bonus game state, the modifier event available within the first and second bonus game states.

3. The gaming machine of claim 1, wherein the one or more modifiable game elements includes a plurality of inactive symbol positions of the bonus array, and wherein the modifier event causes at least one symbol position of the plurality of inactive symbol positions to be activated to include symbols within any subsequent first and second bonus game outcomes.

4. The gaming machine of claim 1, wherein the one or more modifiable game elements includes a persistent award, and wherein updating the persistent award includes updating a value of the persistent award, the persistent award being available for award within the second bonus game feature.

5. The gaming machine of claim 4, wherein the second bonus game feature includes value-bearing symbols linked to the persistent award and having award indicia indicating a corresponding award value, and wherein the award indicia of the value-bearing symbols held in the bonus array are updated by the presentation assembly based on the persistent award.

6. The gaming machine of claim 1, wherein the one or more modifiable game elements including a plurality of persistent awards, the second bonus game feature including a selection sequence including selecting one award of the plurality of persistent awards to be awarded for the second bonus game feature, and wherein updating the plurality of persistent awards in response to the modifier event includes selectively inactivating a first persistent award of the plurality of persistent awards, the inactive first persistent award unavailable within the selection sequence.

7. The gaming machine of claim 1, wherein the first bonus game feature and the second bonus game feature are independently triggered, and wherein untriggered bonus game features of the bonus game are inactive during the bonus game.

8. A method for operating a gaming machine of a gaming system, the gaming system comprising game-logic circuitry in communication with a presentation assembly of the gaming machine, the method comprising:
presenting, via the presentation assembly, a gaming session comprising a base game and a multi-state bonus game including a first bonus game feature and a second bonus game feature; and
conducting, by the game-logic circuitry, the base game by:
causing, by the game-logic circuitry, the presentation assembly to present a base game interface including a plurality of symbol-bearing base reels, a base array, and a plurality of persistent elements including a first persistent element associated with the first bonus game feature and a second persistent element associated with the second bonus game feature;
causing, by the game-logic circuitry, the presentation assembly to spin and stop the plurality of base reels to land symbols from the base reels in the base array; and
in response to the landed symbols including a feature-triggering symbol associated with the first persistent element and a feature-triggering symbol associated with the second persistent element:
animating, by the presentation assembly an addition of the feature-triggering symbol to the associated persistent element via the presentation assembly; and
randomly determining, by the game-logic circuitry, whether or not to trigger the first bonus game feature and the second bonus game feature;
in response to triggering the first bonus game feature and the second bonus game feature, conducting, by the game-logic circuitry, the bonus game with the first bonus game feature for a first duration, the second bonus game feature being inactive during the first duration, wherein the bonus game within the first duration includes:
causing, by the game-logic circuitry, the presentation assembly to present a bonus game interface including a plurality of symbol-bearing bonus reels and a bonus array, the bonus game interface including one or more modifiable game elements associated with the first bonus game feature;
causing, by the game-logic circuitry, the presentation assembly to present one or more first bonus game outcomes by spinning and stopping the plurality of bonus reels to land symbols from the bonus reels in the bonus array; and
in response to detecting the one or more first bonus game outcomes including a modifier event of the first bonus game feature, updating, via the presentation assembly, at least one of the one or more modifiable game elements based on the modifier event, wherein the modifier event is inactive within the base game; and
in response to the first duration concluding, conducting, by the game-logic circuitry and for a second duration, the bonus game with the second bonus game feature and the at least one updated modifiable game elements from the first bonus game feature by causing the presentation assembly to present, via the bonus game interface, one or more second bonus game outcomes based on the second bonus game feature and the at least one updated modifiable game elements.

9. The method of claim 8, wherein the bonus game includes a first bonus game state for the first duration and a second bonus game state for the second duration, and wherein the first bonus game feature continues in combination with the second bonus game feature within the second bonus game state, the modifier event available within the first and second bonus game states.

10. The method of claim 8, wherein the one or more modifiable game elements includes a plurality of inactive symbol positions of the bonus array, and wherein the modifier event causes at least one symbol position of the plurality of inactive symbol positions to be activated to include symbols within any subsequent first and second bonus game outcomes.

11. The method of claim 8, wherein the one or more modifiable game elements includes a persistent award, and wherein updating the persistent award includes updating a value of the persistent award, the persistent award being available for award within the second bonus game feature.

12. The method of claim 11, wherein the second bonus game feature includes value-bearing symbols linked to the persistent award and having award indicia indicating a corresponding award value, and wherein the award indicia of the value-bearing symbols held in the bonus array are updated by the presentation assembly based on the persistent award.

13. The method of claim 8, wherein the one or more modifiable game elements including a plurality of persistent awards, the second bonus game feature including a selection sequence including selecting one award of the plurality of persistent awards to be awarded for the second bonus game feature, and wherein updating the plurality of persistent awards in response to the modifier event includes selectively inactivating a first persistent award of the plurality of persistent awards, the inactive first persistent award unavailable within the selection sequence.

14. The method of claim 8, wherein the first bonus game feature and the second bonus game feature are independently triggered, and wherein untriggered bonus game features of the bonus game are inactive during the bonus game.

15. A gaming system comprising:
a gaming machine including a presentation assembly configured to present a gaming session comprising a base game and a multi-state bonus game including a first bonus game feature and a second bonus game feature; and
game-logic circuitry in communication with the presentation assembly, the game-logic circuitry configured to:
conduct the base game by:
causing the presentation assembly to present a base game interface including a plurality of symbol-bearing base reels, a base array, and a plurality of persistent elements including a first persistent element associated with the first bonus game feature and a second persistent element associated with the second bonus game feature;
causing the presentation assembly to spin and stop the plurality of base reels to land symbols from the base reels in the base array; and
in response to the landed symbols including a feature-triggering symbol associated with the first persistent element and a feature-triggering symbol associated with the second persistent element:
animating an addition of the feature-triggering symbol to the associated persistent element via the presentation assembly; and
randomly determining whether or not to trigger the first bonus game feature and the second bonus game feature;
in response to triggering the first bonus game feature and the second bonus game feature, conduct the bonus game with the first bonus game feature for a first duration, the second bonus game feature being inactive during the first duration, wherein the bonus game within the first duration includes:
causing the presentation assembly to present a bonus game interface including a plurality of symbol-bearing bonus reels and a bonus array, the bonus game interface including one or more modifiable game elements associated with the first bonus game feature;
causing the presentation assembly to present one or more first bonus game outcomes by spinning and stopping the plurality of bonus reels to land symbols from the bonus reels in the bonus array; and
in response to detecting the one or more first bonus game outcomes including a modifier event of the first bonus game feature, updating, via the presentation assembly, at least one of the one or more modifiable game elements based on the modifier event, wherein the modifier event is inactive within the base game; and
in response to the first duration concluding, conduct, for a second duration, the bonus game with the second bonus game feature and the at least one updated modifiable game elements from the first bonus game feature by causing the presentation assembly to present, via the bonus game interface, one or more second bonus game outcomes based on the second bonus game feature and the at least one updated modifiable game elements.

16. The gaming system of claim 15, wherein the bonus game includes a first bonus game state for the first duration and a second bonus game state for the second duration, and wherein the first bonus game feature continues in combination with the second bonus game feature within the second bonus game state, the modifier event available within the first and second bonus game states.

17. The gaming system of claim 15, wherein the one or more modifiable game elements includes a plurality of inactive symbol positions of the bonus array, and wherein the modifier event causes at least one symbol position of the plurality of inactive symbol positions to be activated to include symbols within any subsequent first and second bonus game outcomes.

18. The gaming system of claim 15, wherein the one or more modifiable game elements includes a persistent award, and wherein updating the persistent award includes updating a value of the persistent award, the persistent award being available for award within the second bonus game feature.

19. The gaming system of claim 18, wherein the second bonus game feature includes value-bearing symbols linked to the persistent award and having award indicia indicating a corresponding award value, and wherein the award indicia of the value-bearing symbols held in the bonus array are updated by the presentation assembly based on the persistent award.

20. The gaming system of claim 15, wherein the one or more modifiable game elements including a plurality of persistent awards, the second bonus game feature including a selection sequence including selecting one award of the plurality of persistent awards to be awarded for the second bonus game feature, and wherein updating the plurality of persistent awards in response to the modifier event includes selectively inactivating a first persistent award of the plurality of persistent awards, the inactive first persistent award unavailable within the selection sequence.

21. The gaming system of claim 15, wherein the first bonus game feature and the second bonus game feature are independently triggered, and wherein untriggered bonus game features of the bonus game are inactive during the bonus game.
